(19) United States
(12) Patent Application Publication
(10) Pub. No.: US 2026/0350989 A1
(43) Pub. Date: Nov. 5, 2026

(54) SYSTEM AND METHOD FOR MULTI-MODAL DATA PROCESSING AND ADAPTIVE PERFORMANCE FEEDBACK

(71) Applicant: DOACH, Inc., Richmond, VA (US)

(72) Inventors: Bryon Phelps, Richmond, VA (US); Rory Sparrow, St. Augustine, FL (US)

(73) Assignee: DOACH, Inc., Richmond, VA (US)

(21) Appl. No.: 19/462,988

(22) Filed: Jan. 28, 2026

Related U.S. Application Data
(60) Provisional application No. 63/751,219, filed on Jan. 29, 2025.

(51) Int. Cl. G06V 20/40; G06V 40/20

(52) U.S. Cl. CPC G06V 20/44; G06V 20/42; G06V 40/23

(57) ABSTRACT

A computing system is disclosed for multi-modal event detection, performance evaluation, and adaptive feedback delivery in a sports training environment. The system receives multi-modal input data from a plurality of sensors, including motion, video, biometric, and environmental sources, and synchronizes the data to generate a unified dataset. An event detection model is applied to identify candidate performance events. A temporal portion of the unified dataset corresponding to each candidate event is segmented, and pose data is extracted from the segment. An event-specific analysis model evaluates the pose data to compute one or more performance metrics. A user profile record is retrieved to inform recommendation generation. A feedback instruction is produced based on the performance metric and user profile, assigned a priority value using a rule-based scoring engine, and mapped to a feedback modality. A feedback signal is provided to a user device interface to initiate delivery of the feedback instruction. Replay context records may also be generated for subsequent feedback delivery.

### CROSS-REFERENCE TO RELATED APPLICATIONS

This application claims priority to U.S. Provisional Patent Application No. 63/751,219, entitled “System and Method for Multi-Modal Data Processing and Adaptive Performance Feedback in Sports Training,” filed on Jan. 29, 2025 the entire disclosure of which is incorporated herein by reference in its entirety.

### BACKGROUND

### Field of the Art

The present disclosure relates to computer-implemented systems and methods for multi-modal signal processing and real-time feedback generation. More specifically, the disclosure pertains to technical systems that receive sensor signals from distributed devices and apply a signal transformation pipeline to support feedback delivery in activity environments.

### Discussion of the State of the Art

Athletes increasingly seek personalized training systems that provide real-time guidance across both physical and virtual environments. However, most existing tools offer generic feedback, disconnected from the athlete's specific movements, context, or training history.

Conventional systems lack the ability to transform raw sensor inputs—such as motion data, video frames, and biometric signals—into aligned, interpretable formats for technical evaluation. Without a unified processing pipeline, signal discrepancies due to sampling rate mismatches, timestamp drift, or missing data can undermine performance analysis and delay actionable feedback.

Event detection mechanisms in current systems often operate on rigid thresholds or limited rule sets, lacking a confidence-based feedback loop that determines whether classification is reliable or whether additional data collection is needed. This absence of gated decision logic limits reliability, especially in dynamic training scenarios with partial or noisy sensor input.

Furthermore, performance evaluation is typically not adapted to event-specific requirements. Systems may fail to segment the relevant time window around a detected event, normalize the extracted signals using event-type-specific schemas, or apply modular rule sets that adjust based on user history, session goals, or fatigue level.

Feedback delivery is also underdeveloped in conventional platforms. Many systems cannot dynamically prioritize recommendations based on severity or user context, nor can they adapt modality—audio, visual, haptic—to the delivery environment or coaching persona.

Accordingly, there remains a need in training technologies for systems that can reliably process heterogeneous sensor data, identify relevant performance events, and support dynamic, context-aware feedback without relying on static rules or manual oversight.

### SUMMARY

Systems and methods in accordance with various embodiments of the present disclosure may overcome one or more of the aforementioned and other deficiencies experienced in conventional approaches to multi-modal sports training and performance feedback. In particular, various embodiments describe systems and methods for processing multi-source sensor data to detect athletic events, evaluate performance, and generate prioritized feedback instructions based on machine-executed analysis of user motion, context, and historical training data.

For each detected event, a corresponding analysis model is selected and applied to a segmented portion of the unified dataset. Pose data is extracted and evaluated to compute one or more performance metrics specific to the type of event. These metrics may relate to mechanics, timing, or decision quality and are derived using algorithms configured to process motion vectors, joint positions, and other spatial attributes.

User-specific training context and prior session data are retrieved and incorporated to personalize the evaluation process. One or more recommendations are generated based on the computed metrics and contextual user data. Each recommendation is assigned a priority value using scoring logic that accounts for session goals, recent performance history, and configurable weighting parameters.

The system selects an appropriate delivery method for feedback based on the assigned priority and predefined configuration rules. Feedback may be delivered through one or more channels, including visual, audio, or tactile signals. In some embodiments, feedback is provided in real-time during live execution of an event. In other embodiments, feedback is presented during replay of the relevant event window to support post-hoc analysis and review.

Data streams are temporally aligned using synchronization techniques, and relevant session artifacts are stored for longitudinal performance tracking. Metrics, inputs, and feedback history are logged to enable future model retraining, performance comparisons, and context-aware personalization in subsequent sessions.

The disclosed techniques enable structured event analysis and adaptive feedback without relying on human annotation or real-time human observation. By transforming raw multi-modal data into prioritized and contextualized feedback, the system facilitates a repeatable, machine-executed pipeline for training analysis in physical and virtual environments.

The systems and methods described herein are implemented using computer systems that perform a series of structured, machine-executed operations across a multi-modal data pipeline. These operations include alignment of asynchronous sensor streams, segmentation of event windows, model-based analysis of user movement, and automated delivery of feedback instructions to designated output interfaces. Each step is executed by configured computing components that transform heterogeneous input streams into structured outputs associated with recognized event types. The system does not rely on manual interpretation or heuristics but instead applies trained models and rule-based engines that perform deterministic, traceable transformations over sensor-derived data.

In various embodiments, the system supports schema-conformant formatting of input and output records, enabling interoperability across physical and virtual training environments. Motion data, video frames, and biometric signals are synchronized using timestamp alignment techniques and stored in data structures that allow for replay and reanalysis. Event classification and feedback instructions are encoded in structured records suitable for audit logging, downstream analytics, and longitudinal tracking. This architecture supports internal consistency between detected events, derived performance metrics, and delivered feedback, allowing each output to be mapped to an associated data segment and model invocation.

Additionally, the system includes modular components configured for extensibility and parameterization based on user-specific configurations. For example, rule-based prioritization logic can be dynamically updated based on accumulated performance history or coaching style preferences. Each recommendation or feedback instruction is associated with contextual metadata that captures when, how, and why the instruction was triggered, enabling session replay and scalable adaptation of the training environment. These characteristics demonstrate that the disclosed systems perform specific, technical improvements in machine-executed data processing and structured feedback generation within sensor-driven computing systems.

Various other functions and advantages are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates an example network architecture for multi-modal data processing and adaptive performance feedback in accordance with various embodiments.

FIG. 2 illustrates an example event detection system in accordance with various embodiments.

FIG. 3 illustrates an example recommendation engine and its subcomponents in accordance with various embodiments.

FIG. 4 illustrates an example Model-based feedback generation system and its subcomponents in accordance with various embodiments.

FIG. 5 illustrates an example process for multi-modal data processing, event detection, and performance feedback generation in accordance with various embodiments.

FIG. 6 illustrates an example process for evaluating performance signals and generating prioritized feedback in accordance with various embodiments.

FIG. 7 illustrates an example process for extracting a temporal window of multi-modal sensor data for event-specific analysis in accordance with various embodiments.

FIG. 8 illustrates an example process for selecting and adapting AI coaching personas based on user profile data and session context in accordance with various embodiments.

FIG. 9 illustrates one embodiment of the computing architecture that supports an embodiment of the inventive disclosure.

FIG. 10 illustrates components of a system architecture that supports an embodiment of the inventive disclosure.

FIG. 11 illustrates components of a computing device that supports an embodiment of the inventive disclosure.

FIG. 12 illustrates components of a computing device that supports an embodiment of the inventive disclosure.

### DETAILED DESCRIPTION

The embodiments described herein relate to systems and methods for automated processing of multi-modal sensor data to support event detection, model-based evaluation, and structured feedback generation within a sports training environment. The system is operable to receive asynchronous data streams from distinct sources, including motion sensors, imaging devices, and biometric monitors, and to perform machine-executed transformations that align, segment, and analyze temporal data associated with athletic activity. For each event window identified in the data, the system applies configured analysis models to extract pose information, compute performance metrics, and generate control signals corresponding to feedback instructions. These operations are performed using structured input-output logic, without requiring manual labeling, interpretation, or intervention. In various embodiments, the system further includes functionality for data integrity verification, cross-modal synchronization, model selection based on event type, and execution of scoring routines used to rank and trigger feedback outputs.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Network Architecture

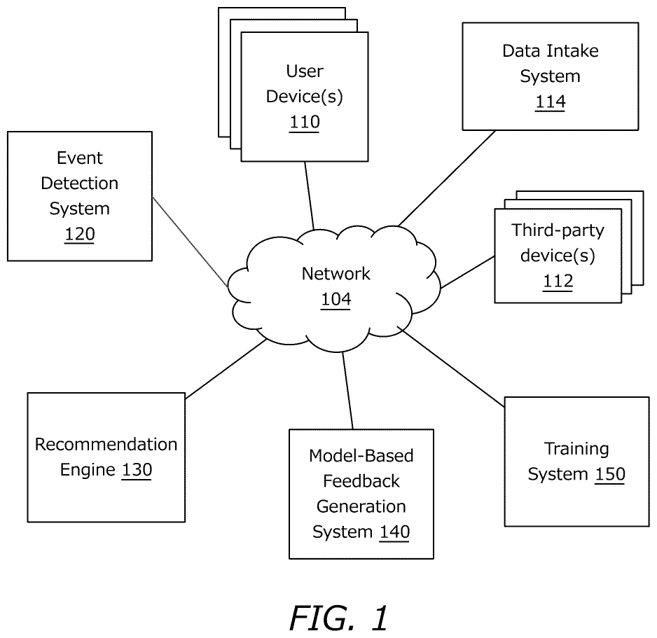

FIG. 1 illustrates the system architecture for a multi-modal data processing and adaptive performance feedback system in accordance with various embodiments. In this embodiment, the system comprises user device(s) 110, third-party device(s) 112, data intake system 114, event detection system 120, recommendation engine 130, Model-based feedback generation system 140, training system 150, data intake system 114, and a network 104, over which the various systems and devices communicate and interact. The components in this architecture interact to enable the capture of heterogeneous data streams from user device(s) 110 and third-party device(s) 112, classification of sports-specific events via the event detection system 120, analysis using event-specific models in the training system 150, and delivery of prioritized feedback through the Model-based feedback generation system 140. The data intake system 114 facilitates preprocessing and integration of multi-modal data, while the data intake system 114 ensures synchronized storage, validation, and large-scale analytics. This architecture supports consistent and personalized performance feedback across both physical and virtual training environments.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

User device(s) 110 represent any computing device operable to interact with the system by collecting, processing, and transmitting data over network 104. These devices are used to facilitate data collection from users, integration with third-party device(s) 112, and communication with other system components, such as event detection system 120, recommendation engine 130, and Model-based feedback generation system 140. User device(s) 110 include, but are not limited to, mobile phones, tablets, laptops, smartwatches, VR headsets, and other computing devices equipped with hardware, software, or embedded logic components.

In certain embodiments, user device(s) 110 leverage built-in capabilities, such as cameras, motion sensors, accelerometers, gyroscopes, and network connectivity, to capture and process multi-modal data. For example, user device(s) 110 may process motion data for limb tracking or capture video streams for pose estimation and event classification. These devices are operable to transmit collected data, including metadata such as timestamps and user identifiers, to the data intake system 114 for preprocessing and synchronization with other system components.

User device(s) 110 may execute additional applications, including web-based interfaces accessed through web browsers such as MICROSOFT EDGE, GOOGLE CHROME, and MOZILLA FIREFOX, or locally installed applications designed for secure interaction with the system. These applications enable users to interact with various system components, transmit data captured during training sessions, and receive feedback from Model-based feedback generation system 140. For instance, user device(s) 110 may allow users to visualize training performance metrics, access tailored feedback, and engage with learning materials that improve their technique or strategy.

In certain embodiments, the applications on user device(s) 110 incorporate secure transmission protocols to ensure the integrity and confidentiality of data shared over network 104. Additionally, these applications may support advanced data visualization features, enabling users to view training progress, access session replays, and analyze key insights derived from their performance data.

The system supports both real-time and asynchronous data interactions, allowing user device(s) 110 to remain functional even in varying network conditions. For instance, when network connectivity is unavailable, user device(s) 110 may locally cache data captured during a training session and synchronize with the data intake system 114 once connectivity is restored. This capability ensures uninterrupted system operation and consistent user engagement across both physical and virtual training environments.

Third-party device(s) 112 represent external devices integrated with the system to enhance data collection and performance analysis. These devices include, but are not limited to, smart balls, fitness trackers, smart courts, and other equipment equipped with sensors or embedded logic for capturing sports-specific data. Third-party device(s) 112 are operable to transmit collected data, such as ball trajectory, motion patterns, or environmental metrics, over network 104 to the data intake system 114 for preprocessing and synchronization.

In certain embodiments, third-party device(s) 112 include specialized equipment for monitoring specific aspects of performance. For example, a smart basketball may capture spin rate and arc during a shooting drill, while a smart court system may track player positioning and movement patterns. These devices enhance the system's ability to classify events and provide detailed performance feedback by supplementing the data collected by user device(s) 110.

Third-party device(s) 112 may interface with the system through standardized communication protocols, such as Bluetooth, Wi-Fi, or proprietary APIs. In certain embodiments, the system includes drivers or integration layers operable to translate data from third-party device(s) 112 into formats compatible with event detection system 120 and training system 150. This ensures seamless integration of external data into the multi-modal processing pipeline.

In scenarios where third-party device(s) 112 are unavailable, the system remains operable to collect and analyze data from user device(s) 110 alone. However, the inclusion of third-party device(s) 112 provides additional granularity and accuracy in performance metrics, enabling the system to deliver more precise feedback and analysis.

Data intake system 114 is operable to receive, preprocess, and synchronize multi-modal data collected from user device(s) 110 and third-party device(s) 112. More specifically, data intake system 114 ensures the alignment and quality of incoming data, enabling accurate classification of events and the generation of meaningful performance insights. Multi-modal data includes, e.g., motion data, video streams, biometric signals, environmental metrics for subsequent processing by event detection system 120, and the like.

In certain embodiments, data intake system 114 includes preprocessing modules for validating data quality and detecting anomalies. These modules employ thresholding, anomaly detection techniques, and machine learning-based validation algorithms to identify and correct issues such as missing data, outliers, or sensor drift. More specifically, data intake system 114 incorporates timestamp synchronization methods, such as Precision Time Protocol (PTP) or high-precision real-time clocks, to align data streams from multiple devices, ensuring temporal consistency across heterogeneous data sources.

In an embodiment, data intake system 114 integrates with external communication protocols, including Bluetooth, Wi-Fi, and proprietary APIs, to facilitate data transfer from third-party device(s) 112. In certain embodiments, data intake system 114 incorporates middleware or driver components operable to translate raw data from third-party device(s) into formats compatible with downstream processing. For example, data captured by smart balls or smart courts may be converted into structured datasets that can be used for pose estimation or trajectory analysis.

In accordance with various embodiments, preprocessing tasks in data intake system 114 may include motion capture data alignment, video understanding, filtering techniques, and the like. For instance, inertial measurement unit (IMU) data collected from wearable devices may be processed using Kalman filters for motion smoothing, while video streams captured from smartphone cameras undergo pose estimation and feature extraction.

In certain embodiments, data intake system 114 is operable to support real-time and asynchronous data workflows. For real-time scenarios, preprocessed data can be transmitted directly to event detection system 120 for classification and analysis. In asynchronous workflows, data intake system 114 caches incoming data locally or transmits it to data intake system 114 for storage and subsequent retrieval. This dual capability ensures that the system remains functional under varying network conditions and supports uninterrupted operation.

Accordingly, by facilitating multi-modal data preprocessing, validation, and synchronization, data intake system 114 ensures the integrity and usability of inputs for downstream components, such as event detection system 120, training system 150, and recommendation engine 130.

Event detection system 120 is operable to classify sports-specific events based on multi-modal data received from data intake system 114. More specifically, event detection system 120 processes preprocessed data streams, such as motion data, video streams, and environmental metrics, to identify events in real time or near-real time. In an embodiment, the events include, e.g., shooting, dribbling, passing, defensive movements, and other activities associated with athletic performance.

In an embodiment, event detection system 120 can employ trained models generated by training system 150, or another appropriate system or component, to classify events. In certain embodiments, event detection system 120 includes a multi-class classification module operable to classify events using machine learning algorithms such as neural networks, decision trees, and random forests. In an embodiment, this module applies feature extraction techniques to identify patterns in the input data, enabling accurate event classification. For example, inverse kinematics may be used to analyze motion data, while pose estimation and signal processing techniques are applied to detect activity patterns in video streams.

To ensure reliability, event detection system 120 can incorporate a misclassification detection module. In an embodiment, this module uses rule-based systems and adversarial networks to identify and address potential classification errors. For instance, predefined rules may validate the plausibility of classified events based on biomechanical constraints or gameplay scenarios. For example, a classified “shooting” event may be cross-referenced with positional and motion data to confirm that the motion corresponds to a shooting action.

In an embodiment, event detection system 120 validates the usability of incoming data through validation algorithms embedded within its architecture. These algorithms apply expert logic, machine learning-based checks, and threshold validations to assess the quality and consistency of input data before classification. For instance, outlier detection methods may identify anomalies in sensor data that could affect classification accuracy.

In certain embodiments, event detection system 120 can support both real-time and asynchronous workflows. For real-time workflows, event detection system 120 processes incoming data streams as they are received, enabling immediate event classification. For asynchronous workflows, the system retrieves cached data from data intake system 114 and performs batch processing to classify events based on pre-trained models.

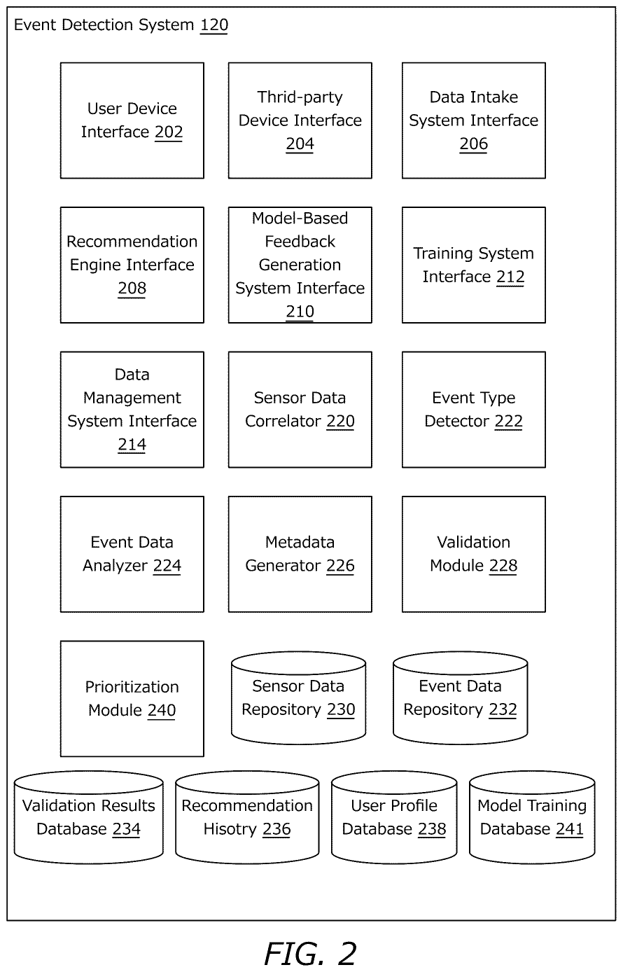

In an embodiment, event detection system 120 outputs classified events and associated metadata, including confidence scores, timestamps, and contextual factors, to recommendation engine 130 for analysis and feedback generation. As will be described further in FIG. 2, event detection system 120 includes various subcomponents and interfaces that support its functionality.

In certain embodiments, training system 150 is implemented as a backend computing system that operates independently of real-time event classification performed by event detection system 120. Training system 150 may be executed on cloud-based computing infrastructure, on-premises servers, or other non-user-facing computing resources, and is invoked asynchronously based on predefined training schedules, data availability thresholds, or model performance criteria. Training system 150 receives training data from one or more system components, including data intake system 114 and associated datastores, and provides trained models and corresponding metadata to event detection system 120 without participating directly in live event detection.

Training system 150 is operable to train event-specific analytical models using diverse datasets that may include historical training data, biomechanical measurements, gameplay scenarios, and environmental parameters. These trained models can then be provided to event detection system 120 for use in classifying sports-specific events. For example, motion capture data obtained from wearable sensors, combined with annotated biomechanical feedback, can be used to train models that evaluate joint angles and limb coordination during events such as shooting and dribbling. Datasets for training also include physiological data such as heart rate and oxygen consumption to support models predicting endurance metrics like fatigue thresholds and recovery rates. In certain embodiments, synthetic data generated through simulations is incorporated into the training process, enabling models to account for scenarios where real-world data is sparse or unavailable.

In an embodiment, training system 150 trains models designed for specific aspects of event classification and performance analysis. For instance, a biomechanics analysis model processes motion data and video streams to detect deviations from optimal posture or movement efficiency. This model applies regression techniques and feature extraction to identify joint-angle abnormalities during shooting drills. Similarly, a cognitive decision-making model is trained using gameplay data annotated with decision outcomes, reinforcement learning simulations, and positional data. For example, this model evaluates passing strategies in a simulated basketball scenario, determining whether a player's choice maximized team advantage. Another example includes an endurance assessment model trained on time-series physiological data, which predicts an athlete's stamina levels during high-intensity drills by evaluating trends in heart rate variability and recovery time.

In accordance with various embodiments, training system 150 outputs trained models, along with associated training metadata such as confidence metrics, model parameters, and versioning data. These models can be stored in data intake system 114 and made available to event detection system 120 for use in real-time event classification. For example, the trained biomechanics analysis model can be deployed by event detection system 120 to evaluate joint movements during a shooting drill, while the decision-making model can assist in classifying tactical decisions during gameplay.

In certain embodiments, training system 150 is operable to periodically update its models based on new data or evolving performance criteria. For example, models may be retrained using additional datasets collected from recent training sessions to improve accuracy and adapt to the user's progress. Updated models are automatically synchronized with event detection system 120 to ensure consistent and reliable event classification.

In an embodiment, the training datasets and methodologies employed by training system 150 incorporate techniques such as biomechanical regression, reinforcement learning, and time-series analysis to ensure robust and adaptive models. By integrating diverse training datasets, leveraging specialized analytical techniques, and providing event detection system 120 with trained models, training system 150 supports accurate event classification and facilitates the generation of actionable feedback throughout the system.

Recommendation engine 130 is operable to analyze outputs generated by event detection system 120 and prioritize actionable feedback for the user. These outputs, including classified events and associated metadata such as confidence scores, timestamps, and environmental conditions, are processed by recommendation engine 130 to generate ranked insights tailored to the user's performance objectives.

In certain embodiments, recommendation engine 130 applies weighted scoring algorithms to rank feedback based on its relevance and priority. For example, during a shooting drill, feedback related to biomechanics, such as deviations in joint angles identified by event detection system 120 using models provided by training system 150, may be prioritized over insights related to endurance. Weighted scoring algorithms consider factors such as model confidence scores, historical performance trends, and session-specific parameters.

In an embodiment, recommendation engine 130 can implement rule-based logic to adapt feedback based on contextual factors such as session type, environment, and user preferences. For instance, during a VR session, feedback related to spatial awareness and decision-making may be prioritized, while in a physical training session, recommendations targeting motion correction or stamina improvement may take precedence.

In certain embodiments, recommendation engine 130 incorporates an adaptive personalization module operable to refine recommendations based on user profiles. These profiles, generated from historical performance data and stored in data intake system 114, include trends and preferences that guide the system's feedback generation. For example, an athlete identified as needing endurance improvement may receive recommendations focusing on stamina-building exercises, while another user may receive agility-focused feedback based on prior session data.

In an embodiment, recommendation engine 130 can transmit its prioritized recommendations to Model-based feedback generation system 140 for delivery to the user. Feedback may be delivered through text-to-speech, visual overlays in a VR environment, or haptic feedback via wearable devices. For example, joint-angle corrections may be displayed as real-time overlays in a VR session, while decision-making guidance may be communicated audibly during a gameplay scenario.

Model-based feedback generation system 140 is operable to deliver actionable feedback to the user based on prioritized insights provided by recommendation engine 130. Feedback is delivered through multiple modalities, including text-to-speech conversion, visual overlays in virtual reality (VR) environments, and haptic feedback via wearable devices. These modalities ensure that feedback is tailored to the user's training session and delivered in a contextually relevant manner.

In certain embodiments, Model-based feedback generation system 140 employs text-to-speech technology to provide real-time audible feedback during physical training sessions. For example, biomechanics-related feedback from recommendation engine 130 may be delivered as precise instructions, such as “adjust your wrist angle by five degrees for optimal shooting accuracy.” The system can dynamically modify the phrasing of feedback based on session intensity, ensuring concise delivery during high-intensity drills and more detailed explanations during review phases.

Model-based feedback generation system is operable to generate dynamic visual overlays for VR-based training environments. These overlays may include trajectory arcs, positional indicators, and annotated diagrams highlighting key areas of improvement. For instance, during a VR basketball shooting drill, the system may display a graphical trajectory overlay representing the optimal shooting path, accompanied by wrist alignment markers to refine technique. These visualizations are rendered in real time, allowing users to immediately perceive and adjust their movements.

In certain embodiments, Model-based feedback generation system 140 delivers haptic feedback via wearable devices, enabling tactile reinforcement of specific actions or movements. For example, during a defensive positioning exercise, the system may use wrist vibrations to guide the user to the correct stance. Similarly, during a dribbling session, haptic feedback can indicate when the user's hand position deviates from an optimal control range.

Model-based feedback generation system 140 integrates feedback metadata provided by recommendation engine 130, including priority levels, timestamps, and contextual factors. For example, high-priority corrections related to biomechanics may be delivered first during a session, while secondary insights, such as stamina-related recommendations, are scheduled post-session to minimize distractions. Additionally, Model-based feedback generation system 140 adjusts its feedback delivery based on session context. For example, in a crowded VR training environment where visual overlays may be overwhelming, the system can prioritize concise audio feedback or haptic signals.

In certain embodiments, Model-based feedback generation system 140 logs feedback interactions and user responses, storing this data in data intake system 114. For instance, the system may record how a user responded to visual wrist alignment corrections during shooting drills or how quickly they adjusted their stance in response to haptic feedback during defensive exercises. These logs enable Model-based feedback generation system 140 to adapt future feedback to align with the user's learning style, such as emphasizing audio cues over visual overlays for users who respond better to auditory instructions.

Model-based feedback generation system 140 employs algorithms to evaluate the optimal feedback modality for each training scenario, leveraging contextual inputs such as session intensity, user preferences, and environmental factors. For example, during a high-intensity endurance drill, concise audio instructions may take precedence over detailed visual cues to reduce cognitive load. Conversely, during a VR review session, the system may prioritize detailed visual overlays to allow the user to analyze their performance comprehensively.

By delivering actionable insights through tailored feedback modalities, Model-based feedback generation system 140 enables users to make precise adjustments in real time and reinforces learning through multi-sensory interaction. This system ensures that feedback aligns with the user's performance objectives, enhancing skill development and overall training effectiveness.

Data intake system 114 is operable to store, organize, and manage the data generated and processed by other components of the system. This includes raw data from data intake system 114, trained models from training system 150, classified events from event detection system 120, and prioritized feedback metadata from recommendation engine 130. More specifically, data intake system 114 ensures that stored information is accessible for future analysis, retraining of models, and longitudinal tracking of user performance trends.

In certain embodiments, data intake system 114 employs a time-series database to store multi-modal data streams with high temporal precision. For example, motion data from wearable sensors, video streams from user device(s) 110, and feedback logs from Model-based feedback generation system 140 are stored with synchronized timestamps to enable cross-referencing and analysis. Time-series data can be used to identify trends such as an athlete's improvement in biomechanics over multiple sessions or changes in endurance metrics during high-intensity drills.

In an embodiment, data intake system 114 can store training datasets and models generated by training system 150. These models are version-controlled to ensure compatibility with event detection system 120. For instance, a new biomechanics model trained on additional data may be deployed alongside a previous version for comparative analysis. Stored datasets include annotated motion capture data, physiological readings, and synthetic data generated through simulations. In certain embodiments, data intake system 114 incorporates indexing techniques and metadata tagging to facilitate efficient retrieval of relevant datasets during model retraining or real-time event classification.

In certain embodiments, data intake system 114 can maintain logs of feedback interactions and user responses recorded by Model-based feedback generation system 140. These logs can include details such as the type of feedback provided, the modality used (e.g., audio, visual, haptic), and the user's response time. For example, the system may log how quickly a user adjusted their wrist angle in response to audio feedback during a shooting drill. These logs are analyzed to adapt future feedback delivery and to assess the effectiveness of training sessions over time.

In accordance with various embodiments, data intake system 114 is operable to perform large-scale analytics on stored data, enabling the identification of patterns and correlations across multiple sessions and users. For example, analytics algorithms may identify that users with similar endurance deficiencies benefit more from real-time haptic feedback than from visual overlays. Insights derived from such analyses can be used to refine training methodologies and improve the system's adaptive capabilities.

In certain embodiments, data intake system 114 supports secure data sharing and synchronization across devices and components. Encryption techniques and secure transmission protocols ensure the integrity and confidentiality of sensitive information, such as user performance data and training logs. For example, classified events and associated feedback may be securely transmitted from the system to a cloud-based dashboard accessible by a coach or analyst for review.

Network 104 facilitates data exchange between various components and devices within the system, including user device(s) 110, third-party device(s) 112, data intake system 114, event detection system 120, training system 150, recommendation engine 130, Model-based feedback generation system 140, and data intake system 114. This network architecture enables both real-time and asynchronous data communication, ensuring that multi-modal data, classified events, prioritized recommendations, and feedback are transmitted efficiently and reliably. Network 104 is operable to support diverse communication protocols and can adapt to varying network conditions to maintain seamless interactions among system components.

In certain embodiments, network 104 encompasses a range of network configurations, including but not limited to local area networks (LANs), wide area networks (WANs), virtual private networks (VPNs), and wireless networks such as Wi-Fi, 4G, 5G, and satellite communications. These configurations enable the system to operate in various environments, from indoor training facilities with high-bandwidth connectivity to remote outdoor locations with limited infrastructure. Network 104 can utilize hybrid networking approaches, combining wired and wireless connections to optimize data transmission and system performance.

One or more links connect each system, module, or device to network 104, facilitating communication through wired, wireless, or optical connections. These links may include Ethernet, fiber-optic cables, Wi-Fi, Bluetooth, or cellular networks, depending on the specific requirements of the system and the deployment environment. In various embodiments, network 104 is operable to prioritize data traffic based on system operations, ensuring that high-priority data, such as real-time motion data and classified events, is transmitted with minimal latency.

The network architecture supports the system's scalability by allowing the addition of new components, such as additional user device(s) 110, databases, or training modules, without requiring significant reconfiguration. This modularity enables the system to expand dynamically in response to increased operational demands or changes in deployment scenarios. For example, new AI coach modules or analytics engines can be seamlessly integrated into the system to support enhanced feedback delivery or more extensive data analysis.

In various embodiments, network 104 includes mechanisms for secure data transmission. These mechanisms may involve encryption protocols, such as Transport Layer Security (TLS) or Advanced Encryption Standard (AES), to protect data in transit. Additionally, authentication mechanisms, including multi-factor authentication (MFA) and public key infrastructure (PKI), ensure that authorized devices and users can access the system. The network may also implement intrusion detection systems (IDS) and firewalls to safeguard against unauthorized access and cyber threats.

Network 104 is operable to support data synchronization across distributed components, enabling the system to maintain consistent and accurate multi-modal data, classified events, and performance metrics. In scenarios where network connectivity is intermittent or unavailable, the system can store data locally on user device(s) 110 and synchronize it with data intake system 114 once connectivity is restored. This capability ensures data continuity and system reliability across diverse operational environments.

In certain embodiments, network 104 may also support edge computing, where data processing and analysis are performed closer to the data source (e.g., on user device(s) 110) to reduce latency and optimize resource usage. This distributed processing model enhances the system's responsiveness and allows real-time decision-making at the edge, while still enabling comprehensive analysis and storage on centralized servers when necessary.

The present disclosure contemplates that network 104 may be designed with redundancy and failover mechanisms to ensure high availability and minimize downtime. These mechanisms include redundant communication links, automatic failover to backup systems, and load balancing across network resources. Such features enhance the system's resilience and ensure continuous operation even in the event of network disruptions or component failures.

In particular embodiments, each system or engine may be a unitary server or may be a distributed server spanning multiple computers or multiple datacenters. Systems, engines, or modules may include hardware, software, or embedded logic components, or a combination of two or more such components for carrying out their respective functionalities. For example, a database server may provide an interface for managing classified events, performance metrics, or training models stored in data intake system 114.

In particular embodiments, one or more data storages may be communicatively linked to one or more servers via one or more links. Data storages may be used to store various types of information, such as multi-modal datasets, user profiles, trained models, or system logs. Information stored in data storages may be organized according to specific data structures, such as relational databases, and interfaces may enable servers or clients to retrieve, modify, add, or delete stored information.

The system may also include additional subsystems and databases, which are not illustrated in FIG. 1 but are apparent to a person of ordinary skill in the art. These may include databases for storing training data, model parameters, classified outcomes, or feedback logs. Additional subsystems and databases may be added or removed as needed to support evolving system functionalities.

### System Architecture

FIG. 2 illustrates the subcomponents, interfaces, and databases of event detection system 120 in accordance with various embodiments. As shown, event detection system 120 includes user device interface 202, third-party device interface 204, data intake system interface 206, recommendation engine interface 208, Model-based feedback generation system interface 210, training system interface 212, and data intake system interface 214. Event detection system 120 further includes sensor data correlator 220, event type detector 222, event data analyzer 224, metadata generator 226, validation module 228, and prioritization module 240. The associated databases include sensor data repository 230, event data repository 232, validation results database 234, recommendation history 236, user profile database 238, and model training database 241.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

User device interface 202 is operable to facilitate the exchange of data between event detection system 120 and user device(s) 110. User device interface 202 receives multi-modal sensor data from user device(s) 110, such as motion data from accelerometers, gyroscopes, or inertial measurement units (IMUs), and video streams from cameras embedded in smartphones or wearable devices. This data is transmitted to sensor data correlator 220 for alignment and processing.

In certain embodiments, user device interface 202 establishes communication with user device(s) 110 using wired or wireless protocols, including Bluetooth, Wi-Fi, USB, or cellular networks. For example, motion data captured by a wrist-worn IMU is transmitted via Bluetooth to event detection system 120, while video data recorded during a training session can be streamed over a Wi-Fi connection. User device interface 202 can adapt its communication method based on the capabilities of the user device and the available network conditions.

In an embodiment, user device interface 202 is operable to manage incoming data streams with differing formats and transmission rates. For instance, motion data may be transmitted at a higher frequency (e.g., 200 Hz) than video data (e.g., 60 fps). User device interface 202 applies buffering and rate adjustment techniques to ensure synchronized delivery of these data streams to sensor data correlator 220. This prevents data misalignment during subsequent processing stages.

In certain embodiments, user device interface 202 is operable to transmit feedback-related metadata to user device(s) 110. For example, metadata such as prioritized event classifications, confidence scores, and contextual information can be sent back to user devices for visualization or further processing by Model-based feedback generation system 140. This enables the user device(s) 110 to display real-time feedback or store event-specific insights for offline review.

User device interface 202 may further support secure data exchange through encryption protocols, such as TLS (Transport Layer Security) or AES (Advanced Encryption Standard), to protect sensitive performance data during transmission. In an embodiment, user device interface 202 also applies authentication protocols to verify the integrity of data sources, ensuring that incoming sensor data originates from authorized user devices.

Third-party device interface 204 is operable to facilitate the exchange of data between event detection system 120 and third-party device(s) 112 and other appropriate systems and components. In an embodiment, third-party device interface 204 receives data inputs, such as environmental metrics, external video streams, or biometric signals, collected by third-party devices, including external cameras, environmental sensors, fitness trackers, or other specialized hardware. This data can be transmitted to sensor data correlator 220 for alignment and processing along with inputs from user device interface 202.

In certain embodiments, third-party device interface 204 establishes communication with third-party device(s) 112 using wired or wireless protocols, such as Ethernet, Wi-Fi, Bluetooth, or industrial communication standards like Zigbee or MQTT. For example, video streams captured by a stationary, high-speed external camera placed on a training court can be transmitted via Ethernet, while environmental metrics such as temperature, humidity, or lighting conditions collected by IoT sensors may be wirelessly transmitted to event detection system 120 over a Zigbee-based network.

In an embodiment, third-party device interface 204 is operable to manage heterogeneous data inputs that may arrive in differing formats, resolutions, or frequencies. For example, high-resolution video streams (e.g., 120 fps) from external cameras may be synchronized with real-time motion data from fitness trackers transmitting at lower rates (e.g., 50 Hz). Third-party device interface 204 applies buffering, data rate normalization, and format conversion techniques to standardize these inputs before forwarding them to sensor data correlator 220.

In certain embodiments, third-party device interface 204 supports integration with biometric devices, such as heart rate monitors, wearable ECG sensors, or oxygen saturation sensors. For instance, a biometric sensor may transmit heart rate data at periodic intervals, which is then correlated with motion and event classification data to evaluate endurance metrics during high-intensity training sessions.

Third-party device interface 204 is operable to handle encrypted or authenticated data streams. For example, biometric signals transmitted by wearable fitness devices may use secure communication protocols such as AES encryption to protect sensitive user information. Third-party device interface 204 applies decryption and authentication mechanisms to validate the integrity and source of incoming data before passing it to sensor data correlator 220.

In certain embodiments, third-party device interface 204 can send metadata or processed insights back to third-party devices for additional actions. For example, insights generated by event detection system 120, such as detected event classifications or performance metrics, may be sent to external displays or dashboards for visualization by coaches or analysts.

Data intake system interface 206 is operable to facilitate the transfer of preprocessed data from data intake system 114 to event detection system 120, and/or other appropriate systems or components. More specifically, data intake system interface 206 ensures the flow of synchronized and standardized multi-modal data, such as motion data, video streams, and environmental metrics, into the subcomponents of event detection system 120 for further processing, classification, and analysis.

In certain embodiments, data intake system interface 206 receives preprocessed datasets that have undergone initial standardization, noise filtering, and alignment in data intake system 114. For example, motion data captured at high frequencies (e.g., 200 Hz) is smoothed and normalized before being transmitted via data intake system interface 206. Similarly, video streams may have been cropped, resized, or annotated with basic metadata such as timestamps or frame rates to ensure compatibility with the downstream processing modules.

Data intake system interface 206 supports batch and real-time data transmission workflows. For real-time workflows, data streams are transmitted continuously, allowing event detection system 120 to classify and analyze events as they occur. In batch processing workflows, data intake system 114 aggregates session data and transmits it to event detection system 120 in larger chunks for asynchronous processing. For example, motion and video data recorded during a training session may be transmitted in batches for post-session analysis.

In certain embodiments, data intake system interface 206 applies validation checks to ensure data integrity and completeness before forwarding it to subcomponents such as sensor data correlator 220. For instance, missing or incomplete data segments may be flagged and requested for retransmission by data intake system 114. This validation process minimizes the risk of errors during event classification and analysis.

Data intake system interface 206 is operable to handle secure data transmission using encryption protocols, such as Transport Layer Security (TLS), to protect the integrity and confidentiality of incoming data. For example, sensitive data, such as biometric signals or environmental parameters, is encrypted during transmission to prevent unauthorized access.

Recommendation engine interface 208 is operable to facilitate the transfer of classified event data, associated performance metrics, and contextual metadata from event detection system 120 to recommendation engine 130. This interface ensures that the outputs generated by event detection system 120 are efficiently delivered for analysis, prioritization, and the generation of actionable recommendations.

In certain embodiments, recommendation engine interface 208 transmits classified events, such as “shooting,” “dribbling,” or “defensive movements,” along with associated performance metrics generated by event data analyzer 224. For example, biomechanical metrics such as joint-angle deviations and movement inefficiencies are transmitted with metadata, including confidence scores, timestamps, and contextual parameters (e.g., environmental data like lighting conditions or surface type).

Recommendation engine interface 208 is further operable to provide prioritization data generated by prioritization module 240. This includes priority scores, ranked event classifications, or weighted performance metrics that guide recommendation engine 130 in determining feedback for the user. For instance, during a shooting drill, recommendation engine interface 208 may transmit prioritized feedback emphasizing wrist alignment over secondary insights such as stance adjustment, based on event-specific importance.

In certain embodiments, recommendation engine interface 208 supports bidirectional communication, enabling recommendation engine 130 to request additional event data or validation checks from event detection system 120. For example, if a recommendation requires enhanced biomechanical analysis, recommendation engine interface 208 facilitates a request for refined outputs from validation module 228 or recalculated performance metrics.

Recommendation engine interface 208 also supports data compression and optimized transmission protocols to ensure low-latency communication between event detection system 120 and recommendation engine 130. For example, classified events and metadata may be transmitted in serialized formats such as JSON or protocol buffer (Protobuf) files to reduce bandwidth usage while maintaining data integrity.

In certain embodiments, recommendation engine interface 208 applies secure transmission protocols, including TLS (Transport Layer Security), to protect the integrity and confidentiality of data exchanged between event detection system 120 and recommendation engine 130.

Model-based feedback generation system interface 210 is operable to facilitate the transfer of prioritized recommendations, event classifications, and associated performance data from event detection system 120 to Model-based feedback generation system 140 and/or another appropriate system or component. More specifically, Model-based feedback generation system interface 210 ensures that the actionable insights generated by recommendation engine 130 are delivered in a format suitable for feedback generation and user interaction.

In certain embodiments, Model-based feedback generation system interface 210 transmits prioritized feedback generated by recommendation engine 130, including real-time performance metrics, recommended adjustments, and contextual metadata. For example, during a shooting drill, Model-based feedback generation system interface 210 may deliver instructions such as “adjust your wrist angle inward by 5 degrees” or “increase your follow-through duration by 0.2 seconds,” derived from biomechanical metrics processed by event data analyzer 224.

Model-based feedback generation system interface 210 is operable to transmit structured metadata supporting feedback delivery. This metadata includes confidence scores, timestamps, event-specific classifications (e.g., shooting, dribbling, or defensive movements), and user profile data retrieved from user profile database 238. For example, a prioritized recommendation regarding stance correction may include a confidence score of 95% and contextual information such as drill duration and training intensity.

In certain embodiments, Model-based feedback generation system interface 210 enables bidirectional communication between event detection system 120 and Model-based feedback generation system 140. This allows Model-based feedback generation system 140 to provide status updates or request additional insights when generating feedback. For example, Model-based feedback generation system 140 may request refined metadata from validation module 228 to enhance the accuracy of delivered instructions or seek supplemental metrics to tailor feedback to the user's preferences.

Model-based feedback generation system interface 210 is operable to support multiple feedback delivery modalities by formatting data appropriately for text, audio, visual, or haptic output. For example, for audio feedback, Model-based feedback generation system interface 210 transmits prioritized instructions optimized for text-to-speech conversion, such as “reduce shoulder tilt for optimized shooting posture;” for visual feedback, the interface transmits event metadata that enables VR overlays or graphical indicators, such as trajectory arcs or highlighted joint positions; for haptic feedback, the interface formats output signals for wearable devices to provide tactile cues, such as vibrations signaling hand position corrections during dribbling drills.

In certain embodiments, Model-based feedback generation system interface 210 applies secure transmission protocols, such as TLS and AES encryption, to ensure that sensitive performance metrics and personalized recommendations are protected during communication. For example, user-specific feedback, including biometric analysis results, is encrypted before transmission to Model-based feedback generation system 140.

Training system interface 212 is operable to facilitate the transfer of trained models and related metadata from training system 150 to event detection system 120 and/or another appropriate system or component. More specifically, training system interface 212 ensures that the analytical modules within event detection system 120 have access to the most up-to-date machine learning models and performance analysis tools required for event classification, validation, and prioritization.

In certain embodiments, training system interface 212 retrieves trained models optimized for specific event types, such as shooting, dribbling, and defensive movements. For example, a biomechanics model trained on annotated motion capture data may be transmitted to event type detector 222 for classifying shooting events, while a decision-making model trained on gameplay scenarios is sent to event data analyzer 224 to evaluate tactical performance metrics during defensive drills.

Training system interface 212 is operable to transmit model metadata, including version numbers, training datasets, and confidence metrics, ensuring compatibility with the subcomponents of event detection system 120. For example, version-controlled models with accompanying confidence scores are supplied to validation module 228 for cross-referencing classification outputs against model-specific thresholds.

In certain embodiments, training system interface 212 supports the bidirectional exchange of data, allowing event detection system 120 to provide feedback to training system 150 for model refinement. For instance, validation results stored in validation results database 234, including flagged misclassifications or anomalies, can be sent to training system 150 through training system interface 212 for retraining models or updating their parameters.

Training system interface 212 is operable to support asynchronous workflows by facilitating the periodic retrieval of updated models and datasets. For example, new versions of endurance assessment models may be automatically fetched and integrated into event data analyzer 224 during scheduled updates, without disrupting real-time event classification.

In certain embodiments, training system interface 212 incorporates secure data transmission protocols, such as Transport Layer Security (TLS) and AES encryption, to protect the integrity and confidentiality of models and metadata. This ensures that proprietary training datasets and machine learning models are securely transferred between training system 150 and event detection system 120.

Data intake system interface 214 is operable to facilitate the exchange of data between event detection system 120 and data intake system 114. This interface ensures that all relevant data, including raw sensor inputs, classified events, validation results, and feedback metadata, can be efficiently stored, retrieved, and synchronized to support both real-time and asynchronous workflows.

In certain embodiments, data intake system interface 214 transmits processed data from event detection system 120, such as classified event types (e.g., shooting, dribbling), performance metrics, and contextual metadata, to data intake system 114 for storage. For example, event-specific data, including timestamps, biomechanical metrics, and environmental conditions, are stored in event data repository 232 for longitudinal analysis and historical tracking.

Data intake system interface 214 is operable to retrieve historical data from data intake system 114 to support ongoing event classification and performance evaluation. For instance, historical user performance data stored in user profile database 238 may be retrieved to provide context for analyzing current training sessions. Similarly, past recommendations stored in recommendation history 236 may be accessed to avoid redundancy in feedback generation by recommendation engine 130.

In certain embodiments, data intake system interface 214 enables validation-related workflows by accessing stored validation results from validation results database 234. For example, misclassification data flagged by validation module 228 can be retrieved for debugging or used to update classification thresholds in real-time workflows.

Data intake system interface 214 supports secure and efficient data transmission using encryption protocols such as AES (Advanced Encryption Standard) and secure communication standards like Transport Layer Security (TLS). For example, sensitive biometric data, including heart rate or oxygen consumption metrics, is encrypted before transmission to ensure compliance with data protection requirements.

In certain embodiments, data intake system interface 214 is operable to manage large-scale asynchronous data synchronization workflows. For example, event detection system 120 may locally cache session data when network connectivity is limited, and data intake system interface 214 can synchronize this data with sensor data repository 230 once connectivity is restored.

Sensor data correlator 220 is operable to receive, align, and integrate multi-modal sensor data from user device interface 202 and third-party device interface 204 to create a unified and synchronized dataset for further processing within event detection system 120. More specifically, sensor data correlator 220 ensures that heterogeneous data inputs, such as motion data, video streams, and environmental metrics, are temporally and spatially consistent to enable accurate event detection and analysis.

In certain embodiments, sensor data correlator 220 performs temporal alignment by synchronizing data streams based on timestamps associated with each data input. For example, motion data captured at a frequency of 200 Hz from wearable IMU sensors is synchronized with 60 fps video streams from user device cameras. Sensor data correlator 220 applies interpolation or decimation techniques to align these data streams on a common temporal scale. For instance, linear interpolation may be used to estimate intermediate data points for motion data, ensuring alignment with video frames.

In an embodiment, sensor data correlator 220 performs spatial alignment by mapping motion data and video data to a unified spatial reference frame. In an embodiment, sensor data correlator 220 employs inverse kinematics and pose estimation algorithms to reconstruct a virtual skeletal model of the user based on the raw motion data from IMUs and visual data from cameras. For example, wrist position data from an IMU sensor is combined with pose landmarks detected in the video stream to generate a spatially coherent representation of the user's arm movement during a shooting drill.

In certain embodiments, sensor data correlator 220 detects and compensates for data inconsistencies or gaps resulting from sensor dropouts, latency, or environmental obstructions. For example, if motion data from a wearable sensor is temporarily unavailable, sensor data correlator 220 applies predictive techniques such as Kalman filtering or spline-based interpolation to estimate missing data points. Similarly, if portions of a video stream are occluded or corrupted, sensor data correlator 220 weights the motion sensor data more heavily to maintain consistency.

Sensor data correlator 220 generates a unified dataset containing synchronized and aligned multi-modal data streams. In an embodiment, the dataset includes annotated motion data, video frames, and environmental metrics, along with contextual metadata such as timestamps, sensor identifiers, and confidence scores. For example, a unified dataset for a shooting event may include: motion data for wrist, elbow, and shoulder angles captured at 200 Hz; corresponding video frames showing shooting posture; environmental data such as lighting levels and floor conditions; and metadata including session timestamps, data quality scores, and source identifiers.

In certain embodiments, sensor data correlator 220 outputs the unified dataset to event type detector 222 for event classification and to validation module 228 for reliability checks. For example, the temporal and spatial alignment achieved by sensor data correlator 220 ensures that wrist-angle motion data aligns precisely with video-based joint position estimates, enabling event type detector 222 to classify the movement accurately as a shooting event.

Event type detector 222 is operable to classify sports-specific events based on the unified datasets generated by sensor data correlator 220. The component receives synchronized multi-modal data streams—including motion signals, pose trajectories, video frames, and environmental context—and applies classification models and feature extraction techniques to determine the presence and type of discrete user events.

In various embodiments, event type detector 222 applies trained classifiers such as neural networks, decision trees, or rule-based engines to distinguish among predefined event categories, including shooting, dribbling, passing, and defensive stances. For example, a neural network trained on annotated IMU and pose data may identify a shooting event based on elbow extension, wrist angle, and shoulder rotation. Alternatively, a rule-based model may use biomechanical thresholds to detect defensive positioning based on knee bend and center-of-mass stability.

Event type detector 222 performs machine-executed feature extraction across each modality to derive relevant classification inputs. From IMU data, it may extract joint velocity, acceleration, and angular displacement. From pose streams, it may extract limb positioning and inter-joint angles. From video frames, it may extract posture dynamics using computer vision algorithms. These extracted features are input to the classifiers to compute a predicted event type and an associated classification confidence score.

In certain embodiments, event type detector 222 includes a confidence-gated routing mechanism to determine downstream processing based on the reliability of the classification. A configurable threshold (e.g., 85%) is used to evaluate the confidence score associated with each predicted event. If the score meets or exceeds the threshold, the classification and associated metadata are transmitted to event data analyzer 224 for performance evaluation. If the score falls below the threshold, event type detector 222 conditionally initiates a data request back to user device interface 202 or third-party interface 204 to obtain additional multi-modal data.

For example, if pose estimation data is partially occluded or IMU frames are missing from the initial classification window, event type detector 222 identifies the incomplete modality and requests supplemental data from the corresponding sensor source. This adaptive behavior enables dynamic correction of low-confidence classifications without manual review, enhancing system robustness during both live and offline workflows.

Event type detector 222 may optionally incorporate contextual signals such as court geometry, session type, lighting, and peer proximity to improve classification accuracy. For instance, a shooting event detected near the perimeter during a solo practice session may adjust decision boundaries differently than a similar movement occurring mid-game under defensive pressure.

In certain embodiments, event type detector 222 supports feedback integration via a closed loop with validation module 228. Misclassifications or anomalies identified post-classification can trigger model reweighting, rule adjustment, or threshold tuning. For example, repeated misclassification of a crossover dribble as a lateral step may prompt the model to increase weighting on lateral hip motion vectors during retraining.

Event type detector 222 supports both real-time and asynchronous workflows. In real-time modes, classifications are computed on streaming input and routed immediately for feedback generation. In asynchronous modes, batch-classified data segments may be stored, reprocessed, or selectively reclassified depending on the results of the confidence-gated mechanism and downstream validation steps.

Event data analyzer 224 is operable to evaluate performance metrics for each classified event received from event type detector 222. More specifically, event data analyzer 224 applies event-specific analytical models, such as biomechanical models, kinematic models, and decision-making models, to generate detailed insights into user performance during detected events.

For example, in an embodiment, event data analyzer 224 processes motion data and video-derived features to compute biomechanical performance metrics. For example, during a classified shooting event, event data analyzer 224 analyzes wrist, elbow, and shoulder angles over time to calculate joint-angle deviations from optimal biomechanical movement. This analysis may indicate issues such as insufficient wrist snap or improper follow-through, which can adversely impact shot accuracy. For dribbling events, event data analyzer 224 evaluates hand-to-ball timing, motion frequency, and limb coordination to detect inconsistencies in dribbling mechanics.

In an embodiment, event data analyzer 224 can apply kinematic analysis models to assess movement efficiency. For instance, kinematic models use regression techniques and inverse dynamics to calculate metrics such as acceleration, velocity, and angular momentum of body segments. For a defensive movement classification, event data analyzer 224 evaluates the user's center of mass, stride efficiency, and lateral quickness to identify areas for improvement.

In certain embodiments, event data analyzer 224 applies decision-making analysis models to evaluate tactical and strategic performance. For example, during a passing drill, event data analyzer 224 may analyze gameplay-derived inputs such as positional data, teammate locations, and event timing to determine whether the user's decision optimized team advantage. Reinforcement learning models or attention-based algorithms can assess decision quality against idealized scenarios.

In certain embodiments, event data analyzer 224 outputs performance insights and associated metadata for each classified event. For example, for a shooting drill, the output may include: quantified wrist and elbow deviations (e.g., 8° inward misalignment); shot release speed (e.g., 0.3 seconds); confidence scores for the analysis (e.g., 92%); and event duration and spatial context (e.g., free-throw line, left court side).

The generated performance insights can be provided to prioritization module 240 and recommendation engine 130 for prioritization and feedback generation.

In certain embodiments, event data analyzer 224 interacts with validation module 228 to ensure the reliability of performance metrics. For example, if inconsistencies are detected in angular velocity data during a shooting drill, event data analyzer 224 can apply anomaly detection techniques to cross-check inputs against biomechanical constraints and flag the data for validation.

In certain embodiments, event data analyzer 224 supports both real-time and asynchronous workflows. In real-time workflows, event data analyzer 224 processes data streams continuously as events are detected, enabling immediate generation of performance metrics. In asynchronous workflows, the analyzer retrieves cached event data from event data repository 232 for batch processing, facilitating detailed post-session analysis.

Metadata generator 226 is operable to generate contextual metadata for each classified event received from event type detector 222 and analyzed by event data analyzer 224. More specifically, metadata generator 226 creates annotations that supplement performance metrics with additional information, such as timestamps, sensor identifiers, confidence scores, spatial coordinates, and environmental parameters, enabling downstream components to contextualize and prioritize feedback effectively.

For example, during a shooting event, metadata generator 226 may annotate the performance insights provided by event data analyzer 224 with: timestamps to indicate the precise moment of the analyzed movement (e.g., “15:23:10.456”); sensor identifiers that specify data sources, such as IMU sensors on the wrist or video frames from a smartphone camera; confidence scores (e.g., 94%) reflecting the reliability of classification and analysis results; spatial coordinates to identify the user's position on the court (e.g., “free-throw line, left side”), and environmental metrics, such as lighting conditions (e.g., “250 lux”) or surface type (e.g., “hardwood”).

In certain embodiments, these annotations can provide a comprehensive context for understanding the detected event and its associated performance metrics.

In certain embodiments, metadata generator 226 is operable to correlate multi-modal metadata with historical records retrieved from event data repository 232 and user profile database 238. For example, metadata generator 226 can annotate a current shooting event with comparative metrics, such as previous wrist-angle deviations and shot release speeds, to highlight improvements or regressions over time.

In an embodiment, metadata generator 226 generates event confidence metadata to account for classification or analysis uncertainties. For example, when multiple motion patterns closely resemble both a shooting and passing event, metadata generator 226 assigns confidence scores to both classifications (e.g., “shooting: 85%, passing: 15%”) to reflect model uncertainty. This confidence metadata may be used by validation module 228 to refine the classification outputs.

Metadata generator 226 outputs the generated contextual metadata along with performance insights to prioritization module 240 and recommendation engine 130. For example, the prioritization module may use metadata, such as confidence scores and spatial coordinates, to rank feedback recommendations, while recommendation engine 130 uses contextual details to generate targeted coaching instructions tailored to specific events.

In certain embodiments, metadata generator 226 supports real-time and batch workflows. In real-time workflows, metadata is generated as events are classified and analyzed, enabling immediate downstream processing. In asynchronous workflows, metadata generator 226 processes stored events in bulk, generating annotations for post-session analysis and longitudinal performance tracking.

In certain embodiments, by supplementing performance metrics with contextual metadata, metadata generator 226 enables downstream components to prioritize, validate, and deliver targeted feedback. The generated metadata enhances the system's ability to contextualize user performance within specific events, environments, and historical trends.

Validation module 228 is operable to assess the accuracy, reliability, and consistency of the classified events and performance metrics generated by event type detector 222 and event data analyzer 224. More specifically, validation module 228 applies rule-based logic, anomaly detection techniques, and machine learning-based checks to identify potential misclassifications, data inconsistencies, or deviations from expected biomechanical or contextual constraints.

For example, in an embodiment, validation module 228 cross-references biomechanical outputs against predefined thresholds and constraints. During a shooting event, if the detected joint-angle deviation exceeds an allowable range (e.g., wrist flexion greater than 30 degrees), validation module 228 flags the output as anomalous and assigns a confidence adjustment (e.g., reducing confidence from 92% to 75%). Similarly, for a dribbling event, validation module 228 checks motion frequency and ball contact timing to detect irregularities, such as missing dribble steps or abnormal hand position transitions.

In certain embodiments, validation module 228 incorporates contextual validation by correlating detected events with environmental data or gameplay scenarios. For example, if a defensive movement classification occurs at an atypical location, such as a free-throw line during shooting practice, validation module 228 may flag the output for review. Contextual parameters, such as spatial coordinates, lighting conditions, and surface types, are cross-referenced to validate event plausibility.

In an embodiment, validation module 228 can identify data inconsistencies caused by sensor dropouts or noise. For example, if motion data from a wearable sensor conflicts with visual pose estimation data, validation module 228 applies anomaly detection algorithms, such as Kalman filtering or statistical outlier detection, to reconcile the conflicting inputs. The module may flag the data for further review or trigger predictive interpolation techniques to generate corrected values.

In certain embodiments, validation module 228 generates validation results, including flags, confidence adjustments, and corrective metadata, which are stored in validation results database 234. For example, a misclassified passing event may be annotated with a validation flag, corrected event label, and adjusted confidence score. These validation results may be retrieved by event data analyzer 224 or provided to training system 150 to improve model accuracy during retraining.

In an embodiment, validation module 228 outputs validated event classifications and performance metrics to downstream components, such as prioritization module 240 and recommendation engine 130. For instance, validated data ensures that the prioritization module ranks recommendations based on reliable and consistent inputs, minimizing errors in feedback generation.

In certain embodiments, by identifying and addressing classification errors, data inconsistencies, and anomalous outputs, validation module 228 enhances the reliability and accuracy of event detection system 120. This can ensure that downstream components operate on validated, high-confidence data, supporting robust and actionable performance feedback.

Prioritization module 240 is operable to rank and prioritize performance insights, recommendations, and associated metadata generated by event data analyzer 224 and metadata generator 226. More specifically, prioritization module 240 applies weighted scoring algorithms, rule-based logic, and personalization frameworks to determine the relative importance of feedback for improving user performance.

For example, during a shooting session, prioritization module 240 may assign higher priority to critical biomechanical insights, such as wrist misalignment (e.g., 8° inward deviation), over secondary recommendations, such as minor stance adjustments. Weighted scoring algorithms can factor in confidence scores, performance thresholds, and user-specific preferences retrieved from user profile database 238 to generate priority rankings. For instance, insights with higher confidence scores (e.g., 95%) are prioritized for immediate feedback, while lower-confidence insights may be queued for secondary review.

In certain embodiments, prioritization module 240 incorporates historical performance data to contextualize recommendations. For example, if a user has repeatedly received recommendations to correct wrist alignment during shooting, prioritization module 240 may elevate feedback related to wrist mechanics over other recommendations. This historical analysis ensures that prioritized feedback aligns with the user's persistent performance issues and training objectives.

In an embodiment, prioritization module 240 can account for real-time contextual factors, such as event type, environmental conditions, and session duration, to adjust feedback priorities dynamically. For instance, during a fatigue-prone endurance drill, prioritization module 240 may prioritize feedback on pacing and recovery metrics over biomechanical corrections. Similarly, during a high-precision shooting drill, feedback related to release speed and follow-through mechanics may take precedence.

In certain embodiments, prioritization module 240 outputs ranked recommendations and performance insights, along with contextual metadata, to recommendation engine 130 for feedback generation. For example, a prioritized list of recommendations for a shooting drill may include: adjust wrist alignment by 8° inward (confidence: 95%); increase follow-through duration by 0.2 seconds (confidence: 92%); and improve stance width by 3 inches (confidence: 88%). The prioritization rankings and metadata ensure that the recommendation engine delivers the most impactful and time-sensitive feedback to the user.

In certain embodiments, prioritization module 240 can operate in both real-time and asynchronous workflows. In real-time workflows, prioritization is performed immediately upon receiving event insights, enabling prompt feedback delivery during live training sessions. In asynchronous workflows, prioritization module 240 processes batch data retrieved from event data repository 232 for post-session analysis and feedback generation.

In certain embodiments, by dynamically ranking and contextualizing performance insights and recommendations, prioritization module 240 ensures that downstream components, such as recommendation engine 130, deliver actionable feedback tailored to the user's most pressing performance needs. This enables focused, efficient training sessions that address high-priority areas for improvement.

Sensor data repository 230 is operable to store multi-modal sensor data received from user device interface 202, third-party device interface 204, and data intake system interface 206. More specifically, sensor data repository 230 stores raw and preprocessed data collected from user device(s) 110 and third-party device(s) 112, enabling event detection system 120 to access and analyze consistent, high-quality inputs during event classification and performance evaluation.

For example, sensor data repository 230 may store: motion data, such as accelerometer, gyroscope, and inertial measurement unit (IMU) readings, captured at high sampling rates (e.g., 200 Hz) during athletic movements; video data, including high-resolution video streams and frame-by-frame pose estimations recorded by smartphone cameras or external cameras; biometric data, such as heart rate, oxygen consumption, or electrocardiogram (ECG) signals received from wearable devices; and environmental metrics, such as temperature, humidity, surface type, and lighting conditions, obtained from third-party sensors.

In an embodiment, these data inputs can be annotated with contextual metadata, such as timestamps, sensor identifiers, sampling frequencies, and data source types, to support alignment and synchronization by sensor data correlator 220.

In certain embodiments, sensor data repository 230 interacts with sensor data correlator 220, which retrieves stored raw sensor data to perform temporal and spatial alignment. For instance, during a post-session analysis, sensor data correlator 220 may fetch IMU data and video frames stored in sensor data repository 230 to generate a unified dataset for downstream processing.

In an embodiment, sensor data repository 230 is can be accessed by validation module 228 for anomaly detection and validation workflows. For example, validation module 228 may retrieve stored sensor data to cross-check inconsistencies or resolve conflicts between motion data and video-based pose estimations.

In certain embodiments, sensor data repository 230 supports both real-time and asynchronous data storage workflows. For real-time workflows, sensor data repository 230 stores incoming sensor data streams as they are received. In asynchronous workflows, sensor data repository 230 allows batch uploads of sensor data collected during offline sessions or when network connectivity is restored.

In accordance with various embodiments, sensor data repository 230 ensures data integrity and accessibility through secure storage mechanisms, such as encryption protocols (e.g., AES encryption) and access control policies. For example, raw biometric signals may be encrypted during storage to safeguard sensitive user information, while access to stored data may be restricted to authorized components, such as event detection system 120.

Event data repository 232 is operable to store classified event data and associated performance metrics generated by event type detector 222 and event data analyzer 224. More specifically, event data repository 232 maintains structured records of detected events, performance insights, and contextual metadata to enable downstream components, such as recommendation engine 130 and prioritization module 240, to access historical and real-time event information for feedback generation and analysis.

For example, event data repository 232 may store: classified events, such as “shooting,” “dribbling,” or “defensive movements,” labeled with corresponding event types; performance metrics, including biomechanical measurements (e.g., joint angles, velocity, acceleration) and kinematic insights (e.g., stride efficiency, center-of-mass stability); contextual metadata, such as timestamps, spatial coordinates, confidence scores, and session identifiers; and event-specific analysis results, including validated outputs (e.g., flagging inconsistencies resolved by validation module 228) and anomaly detection metadata.

For instance, a shooting event record may include wrist misalignment metrics (e.g., 8° inward deviation), shot release speed (e.g., 0.3 seconds), a confidence score of 95%, and spatial context such as “free-throw line, left court side.”

In accordance with various embodiments, event data repository 232 interacts with multiple components of event detection system 120 to support both real-time and historical data retrieval. For example: event type detector 222 writes classified events and their initial metadata into event data repository 232; event data analyzer 224 updates the repository with detailed performance insights and analysis results derived from the detected events; validation module 228 may append validation results, such as flagged anomalies, corrected classifications, or adjusted confidence scores, to existing event records.

In certain embodiments, recommendation engine 130 accesses stored event data and performance metrics from event data repository 232 to generate targeted recommendations based on the user's historical performance. For instance, the recommendation engine may analyze a sequence of past shooting events to identify recurring biomechanical inefficiencies and prioritize feedback accordingly.

In an embodiment, event data repository 232 supports asynchronous workflows for post-session analysis. For example, after a completed training session, batch uploads of classified event data and performance metrics are written to event data repository 232 for subsequent retrieval and longitudinal performance tracking. In real-time workflows, the repository enables immediate storage and access to event data as it is generated.

In an embodiment, event data repository 232 ensures data integrity and accessibility through secure storage mechanisms, such as AES encryption and version-controlled data records. For example, versioned event data allows components, such as training system 150, to retrieve previous analysis outputs to support machine learning model refinement without overwriting existing records.

In accordance with various embodiments, by providing a centralized and secure repository for classified event data, performance metrics, and contextual metadata, event data repository 232 enables downstream components to generate actionable feedback, prioritize recommendations, and analyze longitudinal performance trends.

Validation results database 234 is operable to store validation outcomes, error flags, and confidence adjustments generated by validation module 228. More specifically, validation results database 234 maintains records of detected anomalies, misclassifications, and corrective metadata, enabling downstream components, such as training system 150 and recommendation engine 130, to improve model accuracy, refine feedback prioritization, and maintain high system reliability.

For example, validation results database 234 may store: validation flags, which indicate the presence of errors or inconsistencies (e.g., “misclassification: detected as ‘passing’ instead of ‘shooting’”); corrected outputs, such as reclassified event types or adjusted performance metrics validated by validation module 228; confidence adjustments, which reflect updates to confidence scores after validation (e.g., reducing a classification confidence from 92% to 75% based on biomechanical plausibility checks); anomaly details, including timestamps, affected event types, sensor data conflicts, and thresholds triggering the anomaly.

For instance, during a shooting drill, validation module 228 may flag a detected wrist flexion angle exceeding 30° as implausible, adjust the confidence score downward, and append corrective annotations to the corresponding event record.

In an embodiment, validation results database 234 interacts with components of event detection system 120 and training system 150. For example: validation module 228 writes validation flags, anomaly details, and corrected outputs into validation results database 234 and training system 150 retrieves validation results to refine machine learning models. For instance, flagged misclassifications can be incorporated into new training datasets to improve the accuracy of event-specific analytical models; event data analyzer 224 accesses validation results to cross-reference previously flagged inconsistencies and ensure performance insights are generated from reliable event data.

In certain embodiments, validation results database 234 supports historical tracking of validation outcomes. For example, longitudinal records of recurring anomalies, such as persistent joint-angle deviations in shooting events, can be used to identify systemic model inaccuracies or user-specific performance issues.

Validation results database 234 also enables bidirectional workflows, where components such as event type detector 222 or event data analyzer 224 request validation outcomes to dynamically adjust thresholds or reprocess event classifications. For example, upon retrieving a validation result indicating a recurring conflict between motion data and pose estimation, event type detector 222 can refine its classification parameters in real time.

Validation results database 234 incorporates secure storage mechanisms, including AES encryption and access control policies, to protect sensitive data. For instance, flagged validation outputs that include biomechanical or biometric data are encrypted and restricted to authorized system components, such as training system 150 or recommendation engine 130.

In accordance with various embodiments, by providing centralized storage for validation results, error annotations, and corrective outputs, validation results database 234 supports improved model accuracy, reliable event classifications, and robust downstream feedback generation. This ensures that the system operates on validated, high-confidence data across real-time and post-session workflows.

Recommendation history database 236 is operable to store historical records of recommendations, feedback, and associated user responses generated by recommendation engine 130 and delivered through Model-based feedback generation system 140. More specifically, recommendation history database 236 maintains detailed logs of previously provided recommendations, feedback prioritizations, and user interactions, enabling downstream components to personalize future feedback and identify trends in user performance.

For example, recommendation history database 236 may store: prioritized recommendations, such as “adjust wrist alignment by 8° inward” or “increase follow-through duration by 0.2 seconds,” along with associated confidence scores and timestamps; feedback responses, including whether the user acknowledged or acted on a recommendation, which may be inferred through subsequent performance metrics; performance outcomes, such as improvements or regressions observed after implementing specific recommendations (e.g., shot accuracy increased by 5%); and contextual metadata, including session identifiers, event classifications (e.g., shooting, dribbling), and environmental factors (e.g., “hardwood surface, 250 lux lighting”).

For instance, during a shooting session, recommendation history database 236 may log that a recommendation to improve wrist snap resulted in a measured reduction in joint-angle deviation from 8° to 2°, correlating to a 10% improvement in shooting accuracy.

In certain embodiments, recommendation history database 236 interacts with recommendation engine 130, which retrieves stored records to prevent redundancy in coaching instructions and prioritize new feedback based on past performance. For example, if wrist alignment has been previously addressed and improved, recommendation engine 130 may elevate feedback related to shot release timing in subsequent training sessions.

Recommendation history database 236 can be accessed by prioritization module 240 to adjust scoring algorithms based on historical response patterns. For example, if a user consistently disregards recommendations related to minor stance adjustments, prioritization module 240 may lower the weight assigned to similar recommendations in future sessions.

In certain embodiments, recommendation history database 236 enables longitudinal performance analysis by correlating historical feedback with user progress. For example, performance metrics such as shot accuracy, dribble efficiency, or defensive speed may be compared over time to evaluate the effectiveness of specific recommendations. This data may be provided to training system 150 to support model retraining, ensuring that feedback remains adaptive and aligned with evolving user needs.

Recommendation history database 236 supports real-time and asynchronous workflows. In real-time workflows, new recommendations and user responses are logged immediately as they are generated and delivered. In asynchronous workflows, bulk updates to recommendation history 236 may occur after post-session data analysis, enabling comprehensive tracking of feedback outcomes.

In certain embodiments, recommendation history database 236 incorporates secure storage mechanisms, including AES encryption and access control policies, to protect sensitive user data. For example, user-specific performance outcomes and historical recommendations are encrypted during storage and restricted to authorized components, such as recommendation engine 130 and Model-based feedback generation system 140.

In accordance with various embodiments, by maintaining a comprehensive history of recommendations, user responses, and performance outcomes, recommendation history database 236 enables the system to deliver adaptive, non-redundant feedback tailored to the user's ongoing training progress and performance trends.

User profile database 238 is operable to store user-specific information, historical performance data, preferences, and training objectives to enable personalized feedback and adaptive coaching. More specifically, user profile database 238 maintains comprehensive records of individual user profiles, facilitating the customization of feedback and prioritization of recommendations by components such as recommendation engine 130, prioritization module 240, and Model-based feedback generation system 140.

For example, user profile database 238 may store: user-specific biometric data, such as baseline heart rate, endurance thresholds, and other physiological parameters captured during training sessions; historical performance metrics, including joint-angle deviations, shot accuracy percentages, dribbling efficiency scores, and defensive movement speeds; user preferences, such as preferred focus areas (e.g., shooting drills, defensive movements), training schedules, and feedback modalities (e.g., audio, visual, or haptic); training goals and objectives, such as improving shot release speed to under 0.3 seconds or increasing defensive lateral quickness by 10%. For instance, a user profile for a basketball athlete may include a historical record showing gradual improvements in wrist alignment and shot accuracy over several sessions, along with a preference for audio feedback during shooting drills.

In certain embodiments, user profile database 238 interacts with recommendation engine 130, which retrieves user-specific preferences and historical performance data to tailor recommendations. For example, if a user has previously prioritized feedback on improving follow-through mechanics, recommendation engine 130 may generate targeted coaching instructions for maintaining follow-through consistency during subsequent shooting drills.

In an embodiment, user profile database 238 can be accessed by prioritization module 240, which uses stored preferences and performance trends to adjust the weighting of recommendations. For instance, if a user's profile indicates persistent difficulty with dribbling efficiency, prioritization module 240 may assign higher priority to dribbling-related recommendations.

In certain embodiments, Model-based feedback generation system 140 retrieves user-specific feedback preferences and training objectives to deliver recommendations in the desired modality. For example, a user who prefers visual feedback may receive graphical overlays highlighting joint positions in a VR environment, while a user favoring audio feedback may hear text-to-speech instructions such as “adjust your wrist angle inward by 5 degrees.”

User profile database 238 supports longitudinal analysis by storing historical performance metrics and training outcomes over time. For example, stored records of shot release speed and accuracy can be used to track the user's progress toward achieving predefined goals, such as a 10% accuracy improvement within a six-week training cycle. These insights may also be provided to training system 150 to refine machine learning models based on evolving user performance trends.

User profile database 238 incorporates secure storage mechanisms, including AES encryption and access controls, to protect sensitive user data. For instance, physiological data, such as heart rate or fatigue thresholds, is encrypted during storage, and access is restricted to authorized components, such as recommendation engine 130 and Model-based feedback generation system 140.

Model training database 241 is operable to store machine learning models, training datasets, and associated metadata used by training system 150 to generate, refine, and validate event-specific analytical models. More specifically, model training database 241 maintains version-controlled models, annotated datasets, and performance benchmarks to support accurate event detection and performance analysis.

In an embodiment, model training database 241 can store: machine learning models, such as biomechanical models for joint-angle analysis, kinematic models for movement efficiency, and reinforcement learning models for decision-making analysis; training datasets, including annotated motion data, pose data extracted from video streams, and synthetic data generated to address sparse or underrepresented scenarios; model metadata, such as version numbers, confidence thresholds, training parameters, and accuracy benchmarks (e.g., precision, recall). For example, a biomechanical analysis model trained to evaluate wrist-angle deviations may include metadata such as version 1.3, a precision score of 92%, and feature extraction parameters applied to joint-angle motion data.

Model training database 241 interacts with training system 150, which retrieves training datasets and prior model versions to retrain or update machine learning models. For example, flagged misclassifications retrieved from validation results database 234 can be incorporated into new training datasets to improve classification accuracy for shooting or dribbling events.

In certain embodiments, event detection system 120 accesses the stored models for event classification and analysis. For instance, event type detector 222 may retrieve a decision tree model trained on annotated passing scenarios, while event data analyzer 224 applies a regression-based biomechanics model for joint-angle evaluations.

Model training database 241 supports model version control, allowing components to access specific versions for validation, comparison, and reproducibility. For example, when refining detection accuracy, validation module 228 can retrieve earlier versions of the models to analyze changes in performance benchmarks.

In an embodiment, model training database 241 supports bidirectional workflows where updated models are stored following retraining. For example, after incorporating new session data into a reinforcement learning model, training system 150 can store the updated version, along with training parameters and accuracy benchmarks, back into model training database 241.

To ensure data integrity and security, model training database 241 can incorporate encryption protocols, such as AES encryption, and access control policies. For example, access to stored models and datasets is restricted to authorized components, such as training system 150 and event detection system 120, to protect proprietary models and training data.

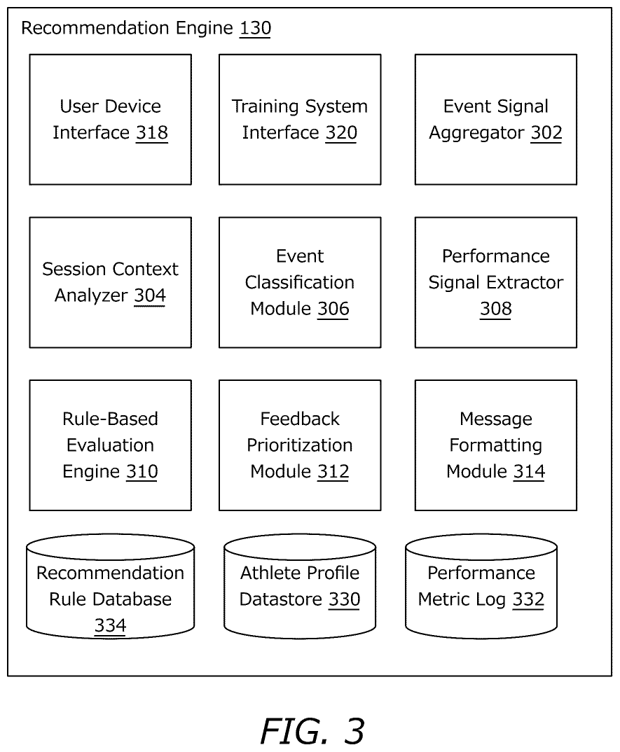

FIG. 3 illustrates an exemplary embodiment of the internal components of recommendation engine 130 in accordance with one embodiment of the invention. Reference numbers are carried over between figures for consistency of explanation, without limiting the scope of any particular embodiment unless expressly stated. As shown, recommendation engine 130 includes event signal aggregator 302, session context analyzer 304, event classification module 306, performance signal extractor 308, rule-based evaluation engine 310, feedback prioritization module 312, message formatting module 314, user device interface 318, training system interface 320, athlete profile datastore 330, performance metric log 332, and recommendation rule database 334. The components depicted are exemplary and may be reorganized, combined, omitted, or distributed across alternative computing environments as would be apparent to a person of ordinary skill in the art.

User device interface 318 is operable to receive input data and deliver output instructions between the computing system and one or more user-associated devices. This includes devices such as smartphones, tablets, wearable sensors, AR/VR headsets, or other physical or virtual equipment associated with athletic activity. The user device interface 318 is configured to support inbound and outbound communication flows with minimal latency and accommodates variable bandwidth or connection states across mobile and stationary hardware environments.

In some embodiments, user device interface 318 receives input streams such as inertial measurement unit (IMU) data, video capture streams, biometric telemetry (e.g., heart rate, skin temperature), or voice prompts generated from device microphones. These signals are buffered, timestamped, and queued for ingestion into the multi-modal processing pipeline. On the output side, user device interface 318 is further operable to transmit feedback instructions to user-facing systems via one or more delivery protocols. This includes triggering audio playback on speakers, rendering visual overlays on displays, or initiating vibration sequences on haptic-capable devices.

User device interface 318 can support protocol translation and abstraction between device-specific signal formats and the internal representation used by the recommendation engine. In some implementations, the interface applies device-specific mappings to ensure that feedback modality instructions are correctly rendered across heterogeneous devices. For example, a feedback signal indicating “posture correction” may trigger a tone on one device, a haptic pulse on another, or a visual guide in a VR environment.

In certain embodiments, user device interface 318 includes device health monitoring and connectivity tracking logic, which can flag incomplete data transfers or misaligned feedback attempts. These records may be stored in session metadata logs for traceability and later processing and review.

Training System Interface 320 is operable to exchange data between the computing system and one or more external training systems, including local or remote computing platforms, video capture systems, sensor aggregators, or third-party performance tracking services. The interface supports both inbound acquisition of raw sensor and contextual data and outbound transmission of computed outputs, feedback instructions, or metadata updates.

Training system interface 320 receives multi-modal input data from external sources associated with the user, including at least one of motion data, video data, biometric signals, and environmental data. This input may be collected from training applications, wearable device hubs, or stationary camera arrays that stream structured or semi-structured telemetry data using interface-specific transport protocols (e.g., REST APIs, MQTT over WebSockets, or binary telemetry formats over BLE). Each received data segment is parsed, timestamped, and normalized to align with the computing system's internal multi-modal processing pipeline.

In various embodiments, training system interface 320 provides the unified dataset to downstream components following temporal synchronization. The interface may be configured to identify transport-specific delays, dropouts, or encoding anomalies, and insert alignment markers or correction flags into a session record. For example, video frames may be received over an RTP stream while IMU data arrives via a low-latency BLE channel, requiring timestamp offset reconciliation before segmentation and event detection are triggered.

On the outbound path, training system interface 320 may deliver feedback signals, performance metrics, recommendation outputs, or synchronization confirmations back to an originating training system. For instance, when the computing system provides a feedback instruction corresponding to a candidate performance event, that instruction may be routed through training system interface 320 to a third-party virtual coaching platform or stored in an external session log for later review.

In some embodiments, training system interface 320 is further operable to support schema-conformant formatting of transmitted data packets. Output records including event labels, performance metrics, and feedback instructions are encoded in a structured format compatible with audit logging, interoperability, or downstream ingestion by analytics platforms. This alignment with structured schema outputs ensures that each transmitted instruction or record maintains traceability to its originating data segment, contributing to system-wide coherence and replay fidelity.

Event Signal Aggregator 302 is operable to receive multi-modal input data from a plurality of sensors associated with a user, the multi-modal input data comprising at least one of motion data, video data, biometric signals, and environmental data. More specifically, event signal aggregator 302 ingests raw data streams from distributed acquisition sources including wearable inertial measurement units (IMUs), smartphone-based video capture, optical tracking systems, ambient temperature or humidity sensors, and biometric collection devices such as heart rate monitors or electromyography (EMG) patches.

Each incoming data stream is time-stamped, source-tagged, and written to a volatile buffer for short-term handling. Event signal aggregator 302 applies interface-specific decoding routines to convert source-specific encodings into a normalized internal representation. For instance, motion vectors arriving via Bluetooth Low Energy (BLE) may be encoded in 16-bit fixed-point format, while video frames streamed from a mobile device may be encapsulated in H.264 format with associated device orientation metadata. Event signal aggregator 302 parses and extracts payloads from each data stream, producing tagged records aligned to a common event session context.

In various embodiments, event signal aggregator 302 is further operable to perform temporal ordering and initial timestamp alignment to allow subsequent synchronization across modalities. Data streams with differing sampling rates are resampled using interpolation or window-based averaging to create intermediate representations with common frame boundaries. For example, biometric signals sampled at 100 Hz may be averaged into 25 Hz windows to align with corresponding video frames recorded at 25 frames per second. These intermediate representations are passed to the synchronization pipeline for generation of the unified dataset aligned across sensor types and temporal dimensions.

To ensure auditability and traceability, event signal aggregator 302 maintains a session record associating each ingested data segment with its acquisition timestamp, source identifier, and transformation lineage. The session record supports downstream segmentation, replay, and model-based evaluation aligned with the candidate performance event lifecycle. In some embodiments, event signal aggregator 302 further supports anomaly detection logic to flag corrupted, missing, or delayed segments, which may be excluded or downweighted in subsequent event classification operations.

Session context analyzer 304 is operable to retrieve a user profile record from a user datastore, the user profile record comprising prior performance metrics, training context data, and coaching configuration parameters associated with the user. More specifically, session context analyzer 304 parses the session metadata and associated user identifier linked to a detected candidate performance event and performs a lookup operation to retrieve one or more structured records representing historical data associated with the user.

The retrieved user profile record includes scalar and vector attributes generated from prior sessions, such as performance scores per event type, fatigue trends, frequency of movement corrections, and feedback response delays. Training context data may include time of day, session duration, environmental conditions, or equipment loadout parameters (e.g., weighted vests, resistance bands). Coaching configuration parameters specify preference hierarchies, feedback thresholds, delivery modalities, and prioritization strategies defined by the coach or the user.

Session context analyzer 304 is further operable to normalize and reconcile the retrieved profile data with the current session context. For example, it may compute deltas between a user's current performance metrics and a rolling average of prior sessions, or identify conflicts between environmental settings and default configuration rules (e.g., suppressing vibration feedback if the user is in a shared environment with haptic interference).

In various embodiments, session context analyzer 304 propagates relevant metadata downstream to a scoring engine or recommendation engine to support context-aware prioritization and delivery of feedback. In one implementation, a configurable scoring weight is dynamically adjusted if the session context indicates that the user is performing a previously problematic event type (e.g., prior repetition failures on squatting maneuvers), allowing the system to shift priority toward corrective feedback for that movement.

To support auditability, session context analyzer 304 appends a session-specific context tag to all downstream recommendation records, enabling traceability of each recommendation to both the current session and relevant historical data. In some embodiments, session context analyzer 304 includes rules to filter or exclude outdated performance metrics outside of a temporal relevancy window, reducing noise in the personalization logic and ensuring the adaptive feedback remains anchored to recent trends.

Session event classification module 306 is operable to apply an event detection model to the unified dataset to identify a candidate performance event associated with the user, the event detection model trained to classify a plurality of predefined event types based on motion and video patterns. More specifically, session event classification module 306 receives a temporally aligned, multi-modal dataset from event signal aggregator 302 and processes a rolling window of data using trained classification logic to identify segments indicative of predefined performance events.

Session event classification module 306 segments a temporal portion of the unified dataset corresponding to the candidate performance event based on detection thresholds, signal patterns, or confidence outputs from a model classifier. The temporal segmentation is performed using fixed-length or dynamic windows (e.g., two seconds pre- and post-trigger), which are stored as timestamp-bounded index ranges in memory and referenced in downstream modules. The module then extracts pose data from the segmented temporal portion using computer vision algorithms and other appropriate techniques. For example, pose extraction may involve estimating skeletal joint coordinates using a 2D or 3D keypoint detection model applied to video frames, or deriving kinematic joint trajectories from inertial measurement unit (IMU) streams.

In various embodiments, session event classification module 306 applies a machine-learned model—such as a convolutional neural network trained on annotated sports events—to evaluate motion trajectories, pose transitions, or sequence timing, and classify the candidate performance event as a specific event type. Event types may include movement initiation, posture transition, repetition failure, target acquisition, or user-defined custom events. In some implementations, the model is configured to detect compound or multi-phase events based on movement cues across time (e.g., load, descend, ascend in a squat). In other implementations, the model may defer classification if a threshold confidence value is not met, flagging the event for manual tagging or post-hoc review.

Session event classification module 306 may also generate a confidence score or classification probability for each candidate performance event, which is stored along with the segmented data and propagated to downstream modules for validation, scoring, or feedback prioritization. In certain embodiments, the classification model is retrainable based on logged performance data or replay-confirmed events, enabling iterative improvement of the detection logic without modifying the session pipeline structure.

In accordance with various embodiments, session event classification module 306 serves as the computational bridge between raw synchronized input and structured event-level analysis, ensuring that each subsequent recommendation and feedback instruction is anchored to a defined, machine-classified performance event within a bounded time segment.

Performance signal extractor 308 is operable to extract pose data from the segmented temporal portion and evaluate the pose data using an event-specific analysis model to compute at least one performance metric corresponding to the candidate performance event. More specifically, performance signal extractor 308 operates on the segmented portion of the unified dataset generated by session event classification module 306 and executes a model-driven sequence of signal refinement, parameter extraction, and feature vector generation tailored to the classified event type.

Performance signal extractor 308 initiates by retrieving pose data associated with the detected segment. In various embodiments, this includes skeletal keypoint positions estimated from video frames using a pose estimation model, or interpolated joint angles derived from IMU data streams. The module filters the raw keypoints using smoothing algorithms or temporal alignment filters (e.g., Savitzky-Golay or Kalman filters) to reduce noise and ensure temporal coherence across frames. Once pose stability is verified, the module identifies biomechanical or kinematic primitives, such as limb extension angles, joint velocities, center-of-mass displacement, or force proxy values (e.g., acceleration-derived ground reaction estimates), that are relevant to the specific event classification.

The extracted signals are mapped to one or more predefined feature sets associated with the event-specific analysis model. For example, if the detected event is a jump shot, the system may compute release angle, vertical displacement, and elbow-knee synchronization; for a lateral movement drill, extracted features may include stride symmetry, hip-ankle vector deviation, or deceleration profile. Performance signal extractor 308 generates a structured feature vector representing these measurements and applies one or more trained models to evaluate the event segment. These models may include regression models for motion range scoring, threshold-based classifiers for rule violations, or kinematic models for evaluating joint coordination and timing relationships.

In some embodiments, performance signal extractor 308 incorporates historical values from the user profile datastore 312 as normalization baselines to compute deviation metrics or scaled performance scores. The computed performance metrics are persisted with temporal identifiers and associated event metadata, providing traceability across training sessions and enabling structured feedback generation in downstream modules.

The signal extraction and evaluation pipeline implemented by performance signal extractor 308 transforms heterogeneous motion inputs into structured event metrics using event-aligned segmentation and model-driven analysis, enabling downstream modules to generate context-aware recommendations anchored to traceable performance events.

Rule-based evaluation engine 310 is operable to assign a priority value to the at least one recommendation using a scoring engine operable to apply rule-based logic and user-specific weighting parameters. More specifically, rule-based evaluation engine 310 receives a performance metric computed by performance signal extractor 308 and a user profile record retrieved from user profile datastore 312. Based on these inputs, rule-based evaluation engine 310 executes a ruleset corresponding to the identified event type and user training configuration to generate one or more recommendations and compute a corresponding priority value for each.

The rule-based logic applied by rule-based evaluation engine 310 includes conditional scoring heuristics defined per event type. For example, if the candidate performance event corresponds to a repetition failure event (e.g., improper form during a squat or jump), the rules may evaluate thresholds on joint angle deviation, tempo irregularity, or frame count between transition phases. Violations of these rules trigger generation of a feedback instruction that is assigned a base priority score. This base score is adjusted based on user-specific weighting parameters derived from recent session history, coaching focus areas (e.g., form over intensity), or accumulated flags from previous events.

In certain embodiments, rule-based evaluation engine 310 supports conflict resolution through tie-breaking logic. For example, if multiple rules trigger simultaneously—such as poor form and suboptimal timing—each corresponding recommendation is scored independently, and the engine resolves priority using a deterministic tie-breaking function. This may include chronological preference (e.g., which violation occurred first), session-criticality weighting, or a fixed hierarchy defined by the user configuration file.

The engine persists each generated recommendation and associated priority value as a structured output object containing: (i) the event identifier; (ii) the performance metric(s) that triggered the rule; (iii) the rule identifier(s) fired; (iv) the assigned priority value; and (v) the recommendation text or code. This output is transmitted to modules, including message formatting module 314 and user device interface 318, for delivery to the user.

In accordance with various embodiments, by separating metric computation from rule evaluation, and by encoding recommendations and priorities in traceable, rule-indexed structures, rule-based evaluation engine 310 enables the system to apply repeatable, machine-executed logic for prioritizing feedback across variable event types and user-specific contexts.

Feedback prioritization module 312 is operable to select a feedback modality based on the priority value and the coaching configuration parameters, the feedback modality comprising at least one of audio output, visual output, or haptic output. More specifically, feedback prioritization module 312 receives the recommendation(s) and associated priority value(s) generated by rule-based evaluation engine 310, as well as a configuration profile associated with the user that specifies permissible feedback channels, session constraints, and priority thresholds for interruptive versus passive feedback delivery.

Feedback prioritization module 312 executes a modality selection function that maps priority values to one or more delivery types. For example, in a live training session, recommendations with a priority value above a predefined threshold (e.g., critical form violation) may be mapped to a real-time audio or haptic cue delivered through a wearable device. Lower-priority feedback, such as minor inefficiencies or optional suggestions, may be deferred and assigned a visual overlay modality to be displayed during a replay sequence or post-session review. This mapping is implemented through a ruleset that associates specific value ranges with one or more output vectors and determines a delivery timing directive (e.g., immediate, delayed, replay-only).

In certain embodiments, feedback prioritization module 312 supports compound feedback scenarios in which multiple recommendations exceed the delivery threshold within a short window. In these scenarios, the module applies a batching function that sequences delivery of the feedback instructions using a cascading timer or merging logic, reducing user overload. Additionally, if the coaching configuration parameters indicate that only non-auditory modes are permitted (e.g., in a quiet training environment), the module filters the candidate modalities accordingly before selecting the output.

Each feedback instruction and its assigned modality are encapsulated as a feedback signal object comprising: (i) an identifier of the associated event; (ii) the feedback content (e.g., “knee angle too wide at landing”); (iii) the assigned modality or combination of modalities (e.g., haptic+visual); and (iv) the transmission target (e.g., headset display, wristband, mobile app overlay). The feedback signal object is then passed to user device interface 318 for execution.

In accordance with various embodiments, by transforming priority values into structured modality selections using deterministic, machine-executed rules grounded in user-specific parameters, feedback prioritization module 312 enables the system to automate delivery channel selection in a traceable and context-aware manner. This structure supports consistent feedback behavior across sessions and training environments.

Message formatting module 314 is operable to generate a feedback signal configured to initiate delivery of the feedback instruction using the selected feedback modality. More specifically, message formatting module 314 receives input parameters from feedback prioritization module 312, including the feedback instruction content, the assigned modality, and the transmission target associated with the user device interface 318.

Message formatting module 314 executes a structured encoding routine in which the feedback instruction is packaged into a machine-readable message format that conforms to the protocol of the designated output channel. For example, if the selected modality is haptic output via a wearable device, the message formatting module 314 generates a low-level signal instruction compatible with Bluetooth or Zigbee protocols, including parameters such as pulse intensity, frequency, duration, and activation timestamp. If the selected modality is visual output, such as an augmented reality overlay, the module generates a payload containing an instruction label (e.g., “Adjust elbow position”), spatial anchor metadata, and rendering directives (e.g., text size, color, placement relative to the field of view).

In some embodiments, message formatting module 314 applies a translation layer for natural language rendering. For instance, if the coaching configuration parameters specify user-preferred phrasing or tone, the module selects from a template set or uses tagging logic to adjust lexical elements in the feedback instruction without altering the underlying performance cue. The resulting instruction may be synthesized into speech using a downstream text-to-speech (TTS) service, with parameters such as pitch, tempo, and voice model ID embedded in the message.

To support delivery timing logic, the message formatting module 314 may also attach timing directives to the feedback signal object, including absolute timestamps for scheduled delivery or relative delays based on proximity to other queued messages. Each formatted message is validated against delivery constraints (e.g., maximum payload size for a headset API, latency tolerance for live haptic feedback), and if needed, segmented or compressed to ensure compatibility.

Once assembled, the finalized feedback signal is passed to user device interface 318, where it is transmitted to the appropriate output device. In some implementations, message formatting module 314 maintains a session-based log of formatted signals, including feedback ID, encoding timestamp, and transmission status, enabling auditability and replay alignment in subsequent sessions.

In accordance with various embodiments, by transforming feedback instructions and modality selections into structured, device-compatible output messages using deterministic formatting logic and protocol-specific instruction sets, message formatting module 314 enables seamless delivery of machine-generated training feedback across physical and virtual interfaces.

Recommendation rule database 334 is operable to store and serve rule-based logic used by feedback prioritization module 312 to assign a priority value to a recommendation based on computed performance metrics, user-specific training context, and configurable coaching parameters. More specifically, recommendation rule database 334 maintains a structured collection of conditional scoring heuristics, tie-breaking rules, and modality selection mappings, each associated with specific event types, user profiles, and system configurations. In various embodiments, each record in recommendation rule database 334 includes a rule identifier, a trigger condition, one or more weighted scoring factors, and an associated action directive. For example, a rule may specify that for a “shooting form collapse” event, if elbow joint angle deviation exceeds 20 degrees and the athlete is in a competitive session, a visual feedback instruction should be assigned a high priority score and delivered immediately. These rules are defined using schema-conformant structures to enable deterministic evaluation by rule-based evaluation engine 310 and feedback prioritization module 312. To support tie-breaking logic, recommendation rule database 334 stores hierarchy directives that indicate how to resolve scoring collisions among multiple feedback candidates. These tie-breaking rules may reference session metadata, such as athlete fatigue levels, coaching preferences, or event frequency. For example, in the event of a scoring tie between two posture-based corrections, the system may elevate the recommendation associated with the higher injury risk or the one occurring more frequently within a defined window. Recommendation rule database 334 may also include mappings between feedback modality types and recommendation categories. For instance, subtle form adjustments may be mapped to visual overlays, while urgent timing corrections may be mapped to audio prompts. These mappings ensure that the feedback delivery remains consistent with the athlete's configuration and coaching intent. In some embodiments, recommendation rule database 334 is structured to support dynamic updates based on longitudinal session data. Rules may be appended, re-weighted, or disabled based on prior system performance, user override signals, or administrative configuration updates. The database may expose a versioning system or logging interface to track changes in rule application over time. By maintaining structured, machine-readable rules that can be evaluated by downstream processing modules, recommendation rule database 334 enables consistent and configurable assignment of priority values and modality mappings. The inclusion of condition-action pairs, scoring thresholds, and deterministic mappings supports automated feedback decisions that are reproducible across sessions and aligned with both user profile data and event-specific performance context.

Athlete profile datastore 330 is operable to store and serve structured user-specific records comprising prior performance metrics, training context data, and coaching configuration parameters. More specifically, athlete profile datastore 330 enables system components to retrieve session-linked metadata and personalization attributes associated with a given athlete identifier to support contextualized evaluation, recommendation generation, and prioritization workflows. In various embodiments, each user record stored in athlete profile datastore 330 includes a unique user identifier, historical performance metrics indexed by event type, a session log with time-stamped feedback interactions, and one or more training configuration parameters. For example, an athlete record may include entries for “jump shot-elbow collapse” with an associated frequency counter, average correction delay, and a trend vector indicating improvement or regression. This historical data is used by feedback prioritization module 312 to compare current performance metrics with historical baselines. Athlete profile datastore 330 further includes training context data that captures attributes such as coaching style preferences (e.g., aggressive correction vs. passive reinforcement), session environment settings (e.g., VR-only, court-based, hybrid), and athlete-defined goal tracking inputs (e.g., focus on speed, posture, or decision accuracy). These context signals are used by scoring engines to personalize which recommendations are generated and how they are prioritized for feedback delivery. In some implementations, athlete profile datastore 330 includes configuration parameters that control system behavior during evaluation or delivery. These may include predefined thresholds for alert generation, flags enabling or disabling certain types of feedback, or weightings to emphasize specific modalities. For example, if a user prefers visual feedback and is engaged in a VR session, the datastore entry may include a modality bias parameter to influence the selection logic in downstream modules. From a structural perspective, athlete profile datastore 330 organizes records using schema-conformant formats that enable consistent mapping between performance metrics, event classifications, and feedback outputs. The data structures support rapid retrieval keyed by athlete ID and event type, with indexing structures optimized for temporal range queries (e.g., retrieve last N session metrics for push-up form deviation). In some embodiments, athlete profile datastore 330 includes derived features generated from longitudinal analysis, such as stability scores, deviation trends, or modality responsiveness metrics. These are precomputed or computed on access and used to refine scoring and recommendation logic during live sessions or replay events. Athlete profile datastore 330 ensures that recommendation generation and priority assignment are grounded in reproducible, machine-readable attributes specific to the user. This enables automated and context-aware adaptation of feedback instructions across varying training environments, while supporting technical reproducibility, data traceability, and longitudinal performance tracking consistent with the inventor-described system pipeline.

Performance metric log 332 is operable to store performance metrics computed for candidate performance events, including event-specific quantitative and qualitative indicators derived from pose data, motion vectors, and other features extracted from the unified dataset. More specifically, performance metric log 332 receives and records machine-generated outputs produced by the rule-based evaluation engine 310, storing them in structured format for session-based analysis, longitudinal comparison, and feedback generation. Each entry in performance metric log 332 is indexed by a session identifier, timestamp, and detected event type. Stored values may include scalar metrics (e.g., joint angle deviation=12.3°), vector-based outputs (e.g., normalized trajectory vector), time-to-completion metrics (e.g., milliseconds between movement onset and gesture completion), or rule-matched flags (e.g., “hip drop detected”). These records serve as an intermediate result store used by downstream modules to support feedback scoring, replay generation, and training trend visualization. In various embodiments, performance metric log 332 includes metadata linking each metric to its source input (e.g., video frame range, sensor ID, pose vector window), the analysis model applied (e.g., kinematic model ID), and the specific evaluation rule triggered (e.g., angular threshold breach). This enables traceability from feedback signals back to raw data and model invocation paths, ensuring deterministic behavior across the system. For example, if the system detects a candidate event classified as a jump shot, the segmented temporal window is evaluated using a kinematic model to compute elbow extension timing, knee flexion range, and post-release body alignment. These individual metrics are recorded to performance metric log 332 along with context tags indicating the athlete ID, session modality (e.g., VR, court), and whether the feedback was delivered live or during replay. The log also supports delta encoding for comparative metrics, such as “repetition N vs. repetition N−1,” to facilitate personalized feedback trends and adaptive threshold adjustment. In some embodiments, performance metric log 332 may be periodically compressed or aggregated using statistical summarization (e.g., moving average of event scores per session) to reduce storage overhead while preserving performance signal integrity. From a structural standpoint, performance metric log 332 is implemented using schema-conformant storage that aligns with the session context, user profile, and feedback instruction formats, allowing modules like feedback prioritization module 312 or message formatting module 314 to directly access and interpret logged data without manual translation. Performance metric log 332 enables the system to maintain a continuous and machine-readable history of athlete performance, supporting consistent evaluation logic, personalized recommendation generation, and reproducibility across both real-time and asynchronous training environments. This log also supports future retraining of analysis models using archived ground truth records and feedback response data.

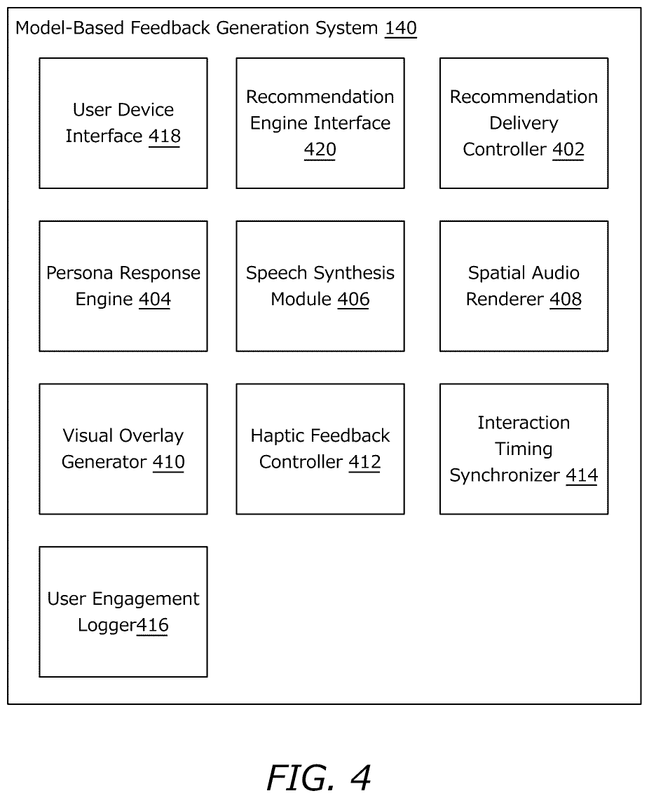

FIG. 4 illustrates an exemplary embodiment of the internal components of Model-based feedback generation system 140 in accordance with one embodiment of the invention. Reference numbers are carried over between figures for consistency of explanation, without limiting the scope of any particular embodiment unless expressly stated. As shown, Model-based feedback generation system 140 includes recommendation delivery controller 402, persona response engine 404, speech synthesis module 406, spatial audio renderer 408, visual overlay generator 410, haptic feedback controller 412, interaction timing synchronizer 414, user engagement logger 416, user device interface 418, and recommendation engine interface 420. The components depicted are exemplary and may be reorganized, combined, omitted, or distributed across alternative computing environments as would be apparent to a person of ordinary skill in the art.

Recommendation delivery controller 402 is operable to direct the delivery of feedback signals to designated output components based on received recommendations. Each recommendation includes a feedback instruction, a selected feedback modality, and a priority value indicating delivery urgency or sequencing. Recommendation delivery controller 402 manages the orchestration, timing, and routing of each feedback instruction in accordance with the configuration parameters associated with the user profile and session context.

More specifically, recommendation delivery controller 402 receives structured feedback instruction packets from recommendation engine interface 420. Each packet includes: (i) a modality identifier (e.g., audio, visual, haptic), (ii) a content payload generated by message formatting module 314, and (iii) a delivery timing parameter, which may be real-time, near-real-time, or linked to a replay segment. Controller 402 parses the packet and determines the appropriate output pipeline for the instruction based on the selected modality and current system state.

For example, if the recommendation specifies delivery during replay of a segmented event, recommendation delivery controller 402 coordinates with interaction timing synchronizer 414 to align the output signal with the replay window. If the recommendation includes simultaneous visual and haptic outputs (e.g., “adjust knee angle”), controller 402 dispatches the visual overlay payload to visual overlay generator 410 and the tactile signal to haptic feedback controller 412 with synchronized delivery markers.

Recommendation delivery controller 402 maintains a delivery queue for pending instructions and applies a priority-aware scheduling algorithm to resolve conflicts or delays. The controller may drop, merge, or reorder instructions based on predefined thresholds or coaching configuration parameters retrieved from athlete profile datastore 330. In one embodiment, controller 402 uses a windowed priority threshold filter to prevent redundant delivery of feedback when multiple overlapping recommendations are queued within a given timeframe.

To support structured logging and traceability, recommendation delivery controller 402 appends a delivery confirmation token and timestamp to each instruction, which is then stored in performance metric log 332. This enables deterministic mapping between the feedback instruction and the triggering performance event, ensuring auditability across live sessions and replays.

In certain embodiments, controller 402 supports delivery logic for multi-modal environments, such as delivering real-time haptic cues during physical drills and synthesized voice feedback during VR replay. These operations are machine-executed and schema-conformant, supporting consistent pipeline behavior across varied user configurations without human intervention.

Persona response engine 404 is operable to generate coaching responses in accordance with a configurable persona style. The persona style defines tone, phrasing, pacing, and behavioral attributes of verbal or visual feedback delivered to the user. These persona configurations are referenced during feedback generation to ensure that instructions are presented in a manner consistent with user preferences, training context, or coaching environment constraints.

More specifically, persona response engine 404 receives a structured feedback instruction from recommendation delivery controller 402. The instruction includes a content payload representing the coaching directive (e.g., “widen stance,” “keep elbow inside frame”), a modality identifier (e.g., audio or visual), and a persona identifier linked to the user profile. Engine 404 parses this information and retrieves associated persona parameters from configuration records, which may include syntactic transformation rules, lexicon mappings, prosody adjustment values, and behavioral modifiers.

For example, if the user's selected persona is configured as a calm, encouraging coach, persona response engine 404 transforms the instruction “correct foot angle” into “let's keep your lead foot pointed straight ahead next time.” Conversely, if a high-intensity persona is selected, the instruction may be rendered more directly as “lead foot too far out—fix it now.” These transformations are performed using pattern substitution rules and tone-selection logic encoded in engine-specific transformation modules.

In audio delivery workflows, persona response engine 404 outputs the transformed text to speech synthesis module 406. In visual workflows, engine 404 passes the text to visual overlay generator 410, optionally including framing markers or emphasis instructions based on persona style (e.g., use of bold annotations or animated gestures in VR overlays). The engine also assigns a delivery tag to ensure consistency when feedback is replayed or delivered in sequence.

Persona response engine 404 further supports multi-lingual output generation by linking persona configuration to available language models. For instance, a bilingual user may receive coaching instructions in English during real-time drills and in Spanish during post-session review, with persona-specific transformations applied in both cases.

In certain embodiments, engine 404 is operable to modify responses based on session context flags received from session context analyzer 304. For example, if a session is marked as high-fatigue or high-pressure, the persona response engine may downgrade feedback intensity or suppress aggressive prompts. These dynamic adjustments are executed based on rule sets that incorporate real-time context and user configuration metadata.

All transformations, selections, and response generation operations performed by persona response engine 404 are structured, deterministic processes implemented by computing logic. Output records are schema-conformant and versioned, supporting consistent replay, audit logging, and integration with downstream delivery components.

Speech synthesis module 406 is operable to generate audio output signals corresponding to structured feedback instructions transformed by persona response engine 404. The module converts structured textual representations of coaching feedback into waveform signals using voice models selected in accordance with user-specific persona configurations and feedback delivery context.

More specifically, speech synthesis module 406 receives a synthesized instruction payload that includes a phoneme-aligned text string, prosodic parameters, and a persona voice model identifier. The module invokes a text-to-speech (TTS) engine configured to apply the voice model and prosodic control instructions to generate an audio signal in real-time or near-real-time. The TTS engine may include concatenative synthesis, parametric synthesis, or neural speech generation techniques depending on system configuration. For example, where a feedback instruction is transformed into the phrase “keep your knees aligned,” the speech synthesis module maps the text to a sequence of phonemes, applies pitch contour and timing derived from the persona model (e.g., calm vs. assertive), and outputs a digital audio file formatted for playback via a mobile speaker, headphone, or virtual reality audio device. If the feedback is marked with an “urgent” tag by the prioritization module, the speech synthesis module increases amplitude or inflection to emphasize the instruction.

In various embodiments, speech synthesis module 406 is configured to embed metadata into the audio signal or associated wrapper files. Such metadata may include a timestamp, recommendation identifier, and replay index to facilitate synchronization with event playback segments or training logs. This enables the system to align audio coaching instructions with video replay or motion-capture visualizations.

Speech synthesis module 406 supports dynamic switching between voice models during a single session. For example, if a user toggles between a primary and secondary coaching persona (e.g., from “encouraging” to “direct”), the module selects the appropriate voice model based on real-time configuration updates and regenerates subsequent audio instructions accordingly. This model-switching is executed via low-latency voice model loaders, ensuring continuous feedback during live or replayed sessions.

The module also supports multilingual instruction generation by referencing language-specific TTS pipelines. When a feedback instruction includes a language switch marker or the user profile specifies multilingual support, the module selects the corresponding phoneme dictionary and voice model to produce audio output in the desired language.

Speech synthesis module 406 outputs the generated waveform to spatial audio renderer 408 for spatialization or directly to user device interface 418 when no spatial audio context is required. All operations are executed by configured computing logic, without reliance on human intervention or heuristic transformation. Output files conform to predefined formats (e.g., .wav, .ogg, or real-time streaming protocol) and are associated with feedback events for indexing, replay, or performance tracking purposes.

Spatial audio renderer 408 is operable to transform mono-channel or stereo audio feedback signals into multi-channel, directionally encoded audio streams for delivery through spatially aware output devices. The component processes synthesized feedback instructions and applies spatialization logic to simulate direction, distance, and environmental acoustics based on session-specific context and user orientation metadata. More specifically, spatial audio renderer 408 receives an input audio waveform—such as that generated by speech synthesis module 406—along with spatial rendering parameters that include user head position, orientation vectors, device geometry, and event location coordinates. The module applies a head-related transfer function (HRTF) or binaural rendering technique to remap the waveform to simulate sound originating from a specific spatial position relative to the user. The rendering parameters may be dynamically updated in real time to match the user's motion and head pose as captured by sensors or headset IMUs.

For example, if a recommendation generated during a dribbling drill instructs the user to “keep left hand tighter,” spatial audio renderer 408 may place the instruction in the user's left auditory field, approximately 45 degrees off-center, to simulate a coach standing nearby. The spatial direction of the audio output is updated continuously if the user rotates their head or changes body orientation. This dynamic rendering is synchronized using timestamp-aligned sensor data and spatial orientation updates streamed via the user device interface 418.

In certain embodiments, spatial audio renderer 408 interfaces with a 3D scene model or virtual environment engine. The component may use environmental context such as wall proximity, floor materials, or ambient sound profiles to apply reverberation filters or occlusion dampening to the spatialized audio. This enables realistic audio feedback when the user is training in simulated gymnasiums, open fields, or home environments, improving localization cues and depth perception.

The component is further configured to support multichannel output formats including ambisonic (B-format), 5.1 surround, or object-based formats (e.g., Dolby Atmos) when supported by the user's playback hardware. Spatial audio renderer 408 selects the appropriate output mode based on device capabilities, user settings, and session configuration data provided by the Model-based feedback generation system 140. Rendered audio streams are encoded and transmitted to user output hardware via device drivers or wireless audio protocols (e.g., Bluetooth LE Audio or Wi-Fi Direct).

Spatial audio renderer 408 includes a rendering scheduler operable to prioritize overlapping feedback instructions based on assigned priority values (as determined by feedback prioritization module 312). When multiple spatial cues must be rendered simultaneously, the module computes a spatial mixing matrix that preserves directional cues while maintaining intelligibility.

In accordance with various embodiments, transformations performed by spatial audio renderer 408 are executed using configured DSP operations and pre-trained spatial models. The component does not rely on user selection or manual positioning and ensures deterministic spatial output aligned with the recommendation delivery timeline and user-specific configuration parameters. Each spatialized audio output is tagged with session metadata and feedback identifiers for replay, logging, and auditing purposes.

Visual overlay generator 410 is operable to generate context-specific graphical outputs corresponding to feedback instructions, performance metrics, and detected event classifications, and to transmit such outputs to a rendering layer associated with a user-facing display device. The graphical outputs are synchronized with session data and temporally aligned with the relevant candidate performance event as determined by the event classification module 306.

The component receives a structured instruction record containing one or more visual elements, including annotated keypoints, directional indicators, timing cues, or contextual graphics, each tagged with a feedback priority value and associated time segment. Visual overlay generator 410 maps each element to a spatial location in the display frame using camera pose data, user-relative coordinates, or virtual environment reference points. In some embodiments, overlay alignment is determined using transformation matrices derived from multi-view camera calibration data or VR headset telemetry.

For example, during a detected shooting event, a recommendation to “elevate elbow during release” may be rendered as a translucent arrow aligned with the user's forearm, extending vertically from the elbow joint. The overlay remains fixed in the user's visual field using scene-locked anchoring if presented in augmented reality, or viewport-relative coordinates if rendered in a 2D interface. Positional accuracy is maintained using joint location vectors extracted by performance signal extractor 308 and head tracking data provided by the user device interface 418.

Visual overlay generator 410 includes a rendering scheduler operable to handle temporal layering, visibility prioritization, and modality coordination. When overlapping visual feedback cues exist within the same session window, the scheduler assigns rendering priority based on the scoring output of feedback prioritization module 312 and the designated delivery modality rules. The module ensures that only the highest-priority overlays are shown when screen space or user attention thresholds are exceeded.

In certain embodiments, visual overlay generator 410 supports adaptive formatting based on user-specific configuration parameters stored in the athlete profile datastore 330. For example, visual instructions may be rendered in contrasting colors for users with color vision deficiencies, or displayed using simplified symbols when the coaching configuration parameter indicates a reduced cognitive load mode.

The component supports both real-time and replay-based rendering workflows. For live feedback, overlay generator 410 streams graphical instructions in parallel with audio or haptic signals, synchronized using a frame-aligned delivery buffer. For replay scenarios, such as during post-session analysis, the component retrieves previously generated overlays from a structured instruction archive and renders them in sequence, aligned with the replayed performance window.

Graphical outputs may be encoded in standard formats such as OpenGL texture buffers, WebGL canvas instructions, or proprietary VR/AR scene graphs depending on the deployment environment. Each overlay instruction is logged with timestamp, user ID, recommendation ID, and event classification metadata to support downstream audit, personalization, and performance review processes.

Visual overlay generator 410 performs all output transformations using deterministic rendering logic and rule-based formatting pipelines. At no point does the system rely on manual interpretation or human-assisted annotation to generate or position overlays. The component transforms structured feedback records into graphical output streams using machine-executed processes aligned with the event detection, pose evaluation, and feedback prioritization pipeline stages.

Haptic feedback controller 412 is operable to transform structured feedback instructions into tactile output signals configured for delivery to one or more user-worn or handheld devices during or following a candidate performance event. The component receives structured control parameters from recommendation delivery controller 402 and translates each instruction into hardware-specific haptic command sequences in accordance with user configuration data and event timing metadata.

Haptic feedback controller 412 includes a vibration profile generator configured to map recommendation types to tactile signal waveforms. For instance, a recommendation indicating a failure to complete full extension in a shooting motion may correspond to a brief pulse at the wrist, while a directional correction (e.g., “shift weight forward”) may trigger a localized pulse sequence along a smart sleeve or compression garment. The selection of waveform, intensity, and location is determined using a combination of feedback priority scores from feedback prioritization module 312 and hardware capabilities exposed by user device interface 418.

In various embodiments, haptic feedback controller 412 implements real-time and replay-aligned haptic triggering. For real-time operation, the controller receives frame-synchronized delivery timestamps and aligns vibration onset with joint positions identified by performance signal extractor 308. This ensures that the tactile signal reinforces the exact moment of deviation or correction. For replay-based analysis, the same vibration sequence is regenerated in coordination with the visual and audio streams rendered by visual overlay generator 410 and speech synthesis module 406.

Haptic feedback controller 412 maintains a device compatibility profile that maps each supported output device to a vibration driver type, waveform encoding format (e.g., LRA, ERM, or piezo command set), and actuation latency offset. These mappings allow the component to pre-compensate for device-specific latency, ensuring synchronized multi-modal delivery when multiple output channels are active. Feedback signals are transmitted using wireless protocols such as Bluetooth Low Energy (BLE) or Wi-Fi Direct, with encryption and timestamp signing enabled for integrity verification and session alignment.

Each tactile instruction issued by haptic feedback controller 412 is logged with session ID, user ID, device ID, feedback ID, and delivery timestamp. These records are transmitted to the performance metric log 332 for longitudinal tracking and system performance auditing. In some embodiments, the controller adjusts future signal parameters using per-user haptic tolerance thresholds derived from prior engagement logs stored in athlete profile datastore 330.

The component supports multiple output strategies, including intensity scaling based on session fatigue data, vibration masking avoidance during overlapping instructions, and staggered sequencing when multiple feedback zones are active. Feedback generation logic is implemented as a rule-based engine with override conditions that disable non-critical signals when competing instructions are present, ensuring cognitive and sensory load management.

In accordance with various embodiments, transformations from feedback instructions to haptic output signals are performed by deterministic, machine-executed processes. At no point does haptic feedback controller 412 rely on user interaction or real-time human oversight to construct or trigger the tactile signals. The component performs a structured transformation of sensor-aligned event metadata into hardware-specific output, contributing to the end-to-end, system-executed feedback pipeline aligned with the core claims and implementation described in the inventor transcript and flowchart.

Interaction timing synchronizer 414 is operable to coordinate delivery timing across multi-modal feedback channels based on event timestamps, frame-aligned segment windows, and modality-specific transmission constraints. The component receives input from feedback prioritization module 312, session event classification module 306, and user device interface 418, and generates synchronization metadata that ensures audio, visual, and haptic signals are temporally aligned during real-time or replay-based feedback. More specifically, interaction timing synchronizer 414 includes a timing resolution engine configured to convert feedback instruction metadata into modality-specific delivery timestamps. These timestamps are calculated based on segmented temporal windows associated with candidate performance events, as determined by event signal aggregator 302. For example, if a recommendation is linked to a movement failure occurring at time T1, the component generates a timestamped instruction block with offset values for each delivery channel: visual overlays (±0 ms), speech synthesis (+200 ms), and haptic feedback (−100 ms), to account for device-specific render and actuation latencies.

To support real-time delivery, interaction timing synchronizer 414 accesses the current system clock and maintains a bounded buffer of upcoming feedback events. The component pre-fetches and sequences instructions within a temporal threshold (e.g., 500 ms) to ensure proactive transmission to downstream delivery modules such as recommendation delivery controller 402. In embodiments supporting replay mode, the synchronizer aligns feedback timestamps with the video frame index of the replay segment, allowing feedback to be injected at the same relative moment observed during the original event capture.

Interaction timing synchronizer 414 applies delivery constraints based on coaching configuration parameters retrieved from athlete profile datastore 330. For instance, certain users may specify preferences for staggered or simultaneous feedback presentation. The component enforces these constraints by sequencing output timestamps in accordance with rule-based delivery profiles (e.g., visual-then-audio, audio-only when visual not available, or all modalities within a ±150 ms synchronization window). Each output sequence is associated with a delivery group ID that enables rollback, reissue, or delay based on downstream status signals.

In various embodiments, interaction timing synchronizer 414 includes latency compensation logic that dynamically adjusts for known or estimated delays introduced by user devices. For example, if a Bluetooth-based haptic device exhibits a 75 ms average latency, the synchronizer shifts its command timestamp accordingly. These adjustments are based on device profiles recorded in prior sessions and stored in the performance metric log 332.

The component also tracks feedback consumption windows and confirmation signals. For example, if a feedback packet is scheduled but not acknowledged by user device interface 418 within a defined interval, the synchronizer may trigger a recovery sequence or downgrade the delivery mode. This ensures robust multi-modal coordination even when one channel experiences disruption or delay.

In accordance with various embodiments, synchronization decisions and timestamp adjustments performed by interaction timing synchronizer 414 are executed deterministically based on system timing, metadata input, and modality constraints. No user interaction is required to coordinate delivery or align modalities. The component transforms abstract feedback instructions into structured, time-aligned signal sets that support system-executed, cross-modal communication workflows, reinforcing its role within the fully automated processing and delivery pipeline.

User engagement logger 416 is operable to record interactions between the athlete and the Model-based feedback generation system, capturing feedback delivery metadata, modality acknowledgment signals, and replay session events for each candidate performance event. The component generates structured engagement records that are timestamp-aligned to feedback transmission, forming a persistent engagement history associated with the user profile. More specifically, user engagement logger 416 monitors signal dispatch activity from recommendation delivery controller 402 and receives feedback status reports from user device interface 418. These reports may include acknowledgment flags (e.g., haptic signal received, visual overlay rendered, speech output completed) and device-specific interaction metrics (e.g., duration of display, volume levels, or device haptic intensity). Each feedback transaction is logged with metadata including the originating recommendation ID, feedback priority value, delivery modality, and timestamp of delivery.

When feedback is delivered during replay mode, as determined by the session context analyzer 304, user engagement logger 416 records replay timing windows, user-controlled playback interactions (e.g., pause, rewind), and any adjustments made to the delivery schedule by interaction timing synchronizer 414. These logs enable post-hoc review of which recommendations were received, how they were presented, and whether delivery occurred as scheduled or required fallback handling.

In some embodiments, user engagement logger 416 includes event-triggered logging logic that associates feedback interaction records with the corresponding candidate performance event. For example, when a movement failure is detected and a correction instruction is delivered via haptic and audio channels, logger 416 stores the temporal linkage between the feedback instance and the event window during which the movement failure occurred. This linkage allows for retrospective visualization of user response to prior coaching instructions, supporting model refinement and downstream analytics.

Logged engagement data is stored in structured records conformant to schema definitions associated with the athlete profile datastore 330 and performance metric log 332. These structured records enable indexing, retrieval, and filtering across session boundaries, and support cohort-level analytics for system-wide feedback effectiveness assessments.

The operations performed by user engagement logger 416 are entirely machine-executed and do not rely on manual tagging or subjective interpretation. Each interaction log entry is derived from deterministic feedback transactions, timing signals, and system state indicators. This enables the system to capture a complete, verifiable record of feedback presentation and user interaction, which can be further used to validate synchronization, audit delivery timing, or refine rule-based feedback prioritization strategies over time.

### A. Computer Implemented Process

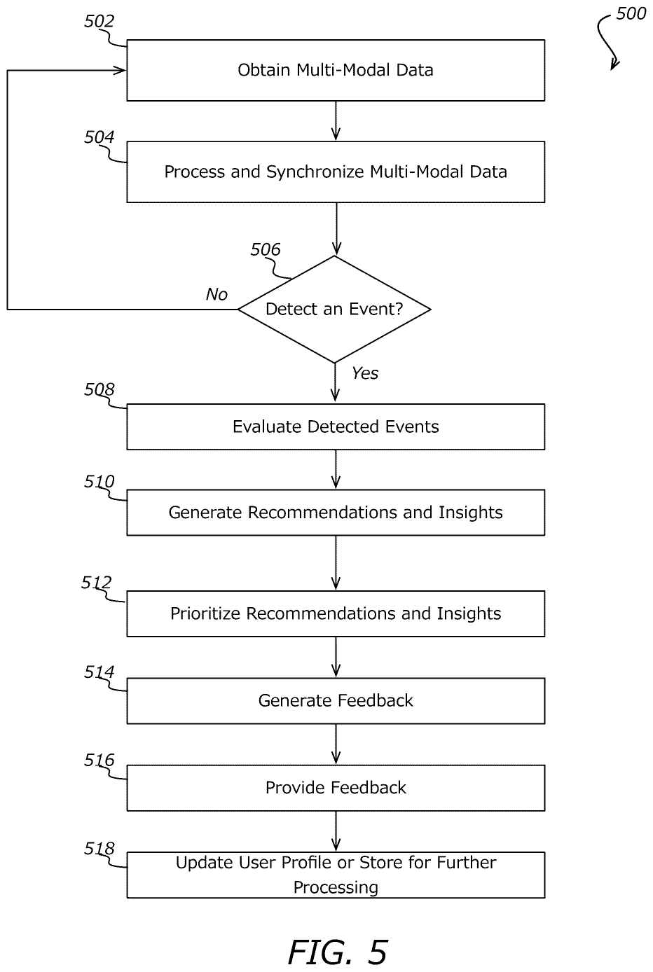

FIG. 5 illustrates an exemplary process 500 for obtaining multi-modal data, detecting events, analyzing performance, generating recommendations, and delivering prioritized feedback in accordance with various embodiments. The steps in this process may be performed by components within event detection system 120 and other interacting systems, such as user device interface 202, third-party device interface 204, data intake system 114, event type detector 222, event data analyzer 224, prioritization module 240, recommendation engine 130, and Model-based feedback generation system 140. The process may include additional steps, fewer steps, or variations in the sequence of steps without departing from the scope of the invention, as would be apparent to one of ordinary skill in the art.

At step 502, multi-modal data is obtained. Multi-modal data may be obtained from, e.g., user device(s) 110 and third-party device(s) 112 through user device interface 202 and third-party device interface 204, respectively. In an embodiment, multi-modal data can include, e.g., motion data, video streams, biometric signals, and environmental metrics that serve as inputs for subsequent event detection and performance analysis. In an embodiment, motion data can include readings from inertial measurement units (IMUs), such as accelerometer and gyroscope data, collected from wearable sensors, such as wristbands or ankle monitors. IMU data captures positional and angular movement of the athlete's body segments during athletic activities. For example, a wrist sensor records angular velocity and acceleration to measure wrist snap during a shooting motion. Video data may include high-resolution video streams captured by cameras integrated into user devices, such as smartphones, tablets, or VR headsets. For example, a smartphone camera may record video of a user performing a dribbling movement, and the system can extract pose data using pose estimation techniques, such as OpenPose or MediaPipe, to determine limb positions, angles, and movement trajectories. Biometric signals, such as heart rate, oxygen saturation (SpO2), and electrocardiogram (ECG) data, may be obtained from third-party wearable devices or sensors. For example, a heart rate monitor may provide real-time heart rate data during a high-intensity defensive movement drill, which can then be correlated to the user's fatigue levels or exertion. Environmental metrics may include, e.g., ambient temperature, humidity, surface type, and lighting conditions obtained from third-party sensors or devices. For example, a pressure sensor embedded in a basketball court surface can measure ground reaction forces during a jump shot, while lighting sensors may record conditions (e.g., 300 lux) that provide contextual data for the video recordings. The multi-modal data, including its contextual metadata such as timestamps, sensor identifiers, and sampling rates, can be transmitted to data intake system 114 for further processing and synchronization at step 504.

At step 504, the system processes and synchronizes the multi-modal data to create a unified dataset for subsequent event detection and performance analysis. Processing can include, e.g., cleaning, normalizing, and aligning the collected motion data, video streams, biometric signals, and environmental metrics to ensure temporal and spatial consistency. In an embodiment, motion data can include readings from inertial measurement units (IMUs), such as accelerometer and gyroscope data, collected from wearable sensors. Motion data can be preprocessed to remove noise and outliers using low-pass filtering techniques. For example, a wrist-worn IMU can record acceleration spikes caused by sensor jitter, which are filtered to produce a cleaner motion trajectory. Normalization techniques, such as min-max scaling, can be applied to standardize motion data across different sensors or users. Video data can include high-resolution video streams captured by cameras integrated into user devices, such as smartphones, tablets, or VR headsets. The video data can be temporally aligned with motion data using timestamps. For instance, a smartphone camera capturing video at 60 frames per second (fps) can be synchronized with IMU motion data sampled at 200 Hz. Pose estimation techniques, such as OpenPose or MediaPipe, can extract body landmarks (e.g., joint positions, limb angles) from video frames, which are mapped to corresponding motion data for precise alignment. Biometric signals, such as heart rate, oxygen saturation (SpO2), and electrocardiogram (ECG) data, can be synchronized with motion and video data. For example, heart rate data sampled at 1 Hz can be temporally interpolated to align with motion data sampled at a higher frequency. This alignment allows physiological states, such as fatigue levels, to be correlated with detected movements or performance metrics. Environmental metrics, such as surface type or lighting conditions, can be spatially and temporally mapped to the corresponding motion and video data streams. For instance, a pressure sensor embedded in a basketball court surface can record ground reaction forces at specific spatial coordinates, while environmental lighting conditions (e.g., 300 lux) can be captured to provide contextual metadata for video recordings. In certain embodiments, sensor data correlator 220 performs preprocessing and synchronization of the multi-modal data. Sensor data correlator 220 can apply algorithms such as Kalman filters or spline interpolation to align data streams and resolve inconsistencies caused by variations in sampling rates or sensor delays. For example, drift in IMU-derived positional data can be corrected using video-derived body landmark positions as a reference. In an embodiment, the alignment process includes per-signal coordination across the following parameters: (i) frame-level timestamps for establishing temporal equivalency across modalities; (ii) sampling rate reconciliation, wherein lower-frequency signals (e.g., 1 Hz heart rate) are interpolated to align with higher-frequency signals (e.g., 60 fps video or 200 Hz IMU); and (iii) sensor ID tagging for maintaining traceability of each aligned data stream to its originating device. Where applicable, Kalman filtering is applied to smooth trajectories and correct for drift, and pose-derived anchor points are used to re-synchronize motion data when clock skew or sampling jitter is detected. This alignment stage ensures that each modality contributes coherent and temporally valid input to downstream classification and evaluation components. The processed and synchronized multi-modal data can then be provided to event type detector 222 at step 506 for event detection. The unified dataset includes aligned motion trajectories, pose landmarks, physiological metrics, and environmental factors, ensuring consistency and accuracy in subsequent analysis.

At step 506, the system determines whether a specific event can be detected based on the processed and synchronized multi-modal data provided by data intake system 114. More specifically, event type detector 222 analyzes the unified dataset to classify events, such as shooting, dribbling, passing, or defensive movements, based on pre-trained machine learning models and other appropriate analytical techniques.

In an embodiment, event type detector 222 can utilize machine learning classifiers, such as neural networks, decision trees, or random forests, to analyze input features extracted from the multi-modal data. For example, IMU-derived motion data, such as acceleration and angular velocity, can be used to identify repetitive hand-to-ball interactions indicative of a dribbling event. Similarly, pose data extracted from video streams can be processed using convolutional neural networks (CNNs) to detect a shooting motion by identifying the alignment of wrist, elbow, and shoulder joints. The system can apply feature extraction techniques to isolate event-specific characteristics from the multi-modal dataset. For example, during a dribbling event, key features such as the frequency of hand-to-ball contact, hand position relative to the torso, and ball bounce timing can be extracted from IMU and video-derived pose data. In another embodiment, during a shooting event, extracted features may include joint angles, shot release speed, and the angular trajectory of the wrist and elbow. The event detection process can include a confidence threshold evaluation to ensure reliable event classification. For instance, if the classification confidence score for a detected event (e.g., shooting) meets or exceeds a predefined threshold (e.g., 85%), the system proceeds to step 508 for performance evaluation. In situations where the confidence threshold is not satisfied, the system can return to step 502 to obtain additional multi-modal data for reprocessing. For example, if the system fails to confidently classify an event due to incomplete pose data from a smartphone camera, it may trigger the collection of supplementary motion data from IMU sensors or additional video frames. This ensures that events are only passed to subsequent steps when classification accuracy is sufficient. In certain embodiments, inverse kinematics and signal processing techniques may be applied to enhance event detection accuracy. For example, inverse kinematics can estimate joint angles and segment trajectories from motion and pose data, while signal processing techniques, such as Fourier transforms, can identify frequency patterns corresponding to repetitive movements (e.g., dribbling at a specific rhythm). The output of step 506 includes classified event types, associated confidence scores, and contextual metadata, such as timestamps, spatial coordinates, and sensor identifiers. For example, a detected shooting event may include the following metadata: event type: Shooting; confidence score: 92%; timestamp: 15:22:08; sensor sources: IMU wrist sensor, smartphone video camera; spatial location: Free-throw line, center court. Events meeting the confidence threshold are passed to event data analyzer 224 at step 508 for performance analysis. Events that fail to meet the threshold return to step 502 for additional data collection, ensuring accuracy and reliability in downstream processes.

At step 508, the system evaluates the detected events received from event type detector 222 to generate performance metrics and insights. More specifically, event data analyzer 224 processes the classified events using event-specific analytical models, such as biomechanical models, kinematic models, and decision-making models, to analyze user performance during the detected events. In an embodiment, biomechanical models can process motion data and video-derived pose data to evaluate joint angles, movement trajectories, and posture during a detected event. For example, during a shooting event, event data analyzer 224 can calculate the wrist, elbow, and shoulder angles over time to determine deviations from optimal biomechanical movement. The analysis may identify issues such as insufficient wrist snap (e.g., 10° deviation) or improper follow-through, which could adversely impact shot accuracy. In certain embodiments, kinematic analysis models are applied to assess movement efficiency and fluidity. For instance, during a dribbling event, event data analyzer 224 can compute metrics such as hand-to-ball timing, movement frequency, and limb coordination. Inconsistent dribbling patterns may be identified based on irregular hand motion or delays in ball contact. Similarly, for defensive movements, kinematic analysis may evaluate center-of-mass shifts, lateral quickness, and stride efficiency to identify areas for improvement. In an embodiment, decision-making models analyze event-specific inputs to assess tactical and strategic performance. For example, during a passing event, event data analyzer 224 may process positional data, teammate locations, and event timing to evaluate whether the user's decision maximized team advantage. Reinforcement learning models and attention-based algorithms can compare the user's choice against idealized scenarios to determine decision quality. In certain embodiments, event data analyzer 224 applies anomaly detection techniques to validate the reliability of performance metrics. For instance, if the system detects unusually high acceleration data during a shooting motion (e.g., 50 m/s²), anomaly detection can flag the data for further validation by validation module 228 to confirm its accuracy. The outputs generated by event data analyzer 224 can include detailed performance metrics, insights, and contextual metadata for each detected event. For example, for a shooting event, the output may include: wrist angle deviation: 8° inward misalignment, shot release speed: 0.35 seconds; confidence score: 93%; event duration: 3.2 seconds; spatial context: Free-throw line. The evaluated performance metrics and insights can be passed to prioritization module 240 at step 510 for further ranking and recommendation generation. By analyzing detected events with event-specific models, step 508 enables the system to produce actionable and detailed insights into user performance.

At step 510, the system generates recommendations and insights based on the performance metrics and contextual metadata evaluated by event data analyzer 224 at step 508. More specifically, recommendation engine 130 processes the performance insights to determine actionable feedback tailored to the user's performance deficiencies, strengths, and training objectives. In an embodiment, recommendation engine 130 can apply rule-based logic, weighted scoring algorithms, and heuristic frameworks to convert performance metrics into event-specific recommendations. For example, for a shooting event, the system may analyze wrist angle deviations and shot release speed to generate a recommendation such as, “Adjust wrist angle inward by 5° to improve shot accuracy.” In certain embodiments, recommendation engine 130 generates insights based on historical performance data retrieved from user profile database 238. For instance, the system may compare the user's current shot accuracy metrics to historical shooting sessions to identify performance trends. If the user consistently demonstrates slow shot release speeds, the recommendation engine can prioritize improving shot timing with feedback like, “Increase shot release speed by 0.2 seconds.” In an embodiment, recommendation engine 130 can generate recommendations for event types involving multiple performance variables. For example, during a dribbling event, the system may analyze hand-to-ball timing, movement frequency, and biomechanical posture to generate combined feedback such as, “Reduce hand-to-ball contact delay by 0.1 seconds and maintain torso upright posture for improved dribbling control.” In certain embodiments, recommendation engine 130 incorporates contextual factors, such as environmental conditions or session objectives, into the recommendation process. For example, during a defensive movement session, the system may analyze fatigue levels derived from heart rate variability data and recommend, “Take a 2-minute recovery break to maintain lateral quickness.” The outputs generated by recommendation engine 130 can include prioritized recommendations, performance insights, and confidence scores. For example, a generated recommendation output may include: recommendation: adjust wrist angle inward by 5°; confidence score: 95%; performance metric: 8° inward misalignment detected; context: shooting event, free-throw drill. The generated recommendations and insights can then be passed to prioritization module 240 at step 512 for ranking and refinement. By generating actionable and event-specific recommendations, step 510 enables the system to address performance deficiencies and support the user's training objectives.

At step 512, the system prioritizes the recommendations and insights generated by recommendation engine 130 at step 510. More specifically, prioritization module 240 applies weighted scoring algorithms, rule-based logic, and user-specific frameworks to rank recommendations and insights based on their importance, relevance, and potential impact on performance. In an embodiment, prioritization module 240 assigns priority scores to each recommendation using predefined weights, confidence scores, and historical user performance trends retrieved from user profile database 238. For example, a recommendation to adjust wrist angle during a shooting event may receive a higher priority score if the deviation exceeds a predefined threshold (e.g., 10° misalignment) and the user has a history of wrist-related performance issues. In certain embodiments, prioritization module 240 can account for real-time session factors, such as session type, event frequency, or user fatigue levels. For example, during an endurance-focused session where heart rate variability indicates elevated fatigue, prioritization module 240 may prioritize recovery-related recommendations, such as “Take a 2-minute rest,” over minor biomechanical corrections. Conversely, during a precision-focused shooting drill, recommendations addressing shot accuracy and wrist alignment may receive the highest priority. In an embodiment, prioritization module 240 integrates confidence scores generated by recommendation engine 130 to influence the ranking of recommendations. For example, a recommendation with a confidence score of 95% for wrist-angle correction may be prioritized over another recommendation with a confidence score of 80%, ensuring that high-certainty feedback is delivered first. Prioritization module 240 can refine rankings based on user preferences and training goals retrieved from user profile database 238. For instance, if a user has indicated a preference for improving shot release speed, prioritization module 240 may elevate recommendations targeting release timing adjustments above recommendations addressing stance or posture. The prioritized recommendations and insights include metadata that supports downstream delivery processes. For example, a prioritized recommendation output may include: rank: 1; recommendation: adjust wrist angle inward by 5°; confidence score: 95%; relevance: sser history of wrist misalignment issues; context: shooting event, free-throw drill, fatigue levels stable. The prioritized recommendations and insights are then passed to Model-based feedback generation system 140 at step 514 for feedback generation. By ranking recommendations based on confidence, real-time conditions, and user-specific factors, step 512 ensures that the most relevant and impactful feedback is prioritized for delivery.

At step 514, the system generates actionable feedback based on the prioritized recommendations and insights received from prioritization module 240 at step 512. More specifically, recommendation engine 130 processes the ranked recommendations to produce tailored feedback that can be delivered in multiple formats, including audio instructions, visual overlays, and haptic signals, through Model-based feedback generation system 140. In an embodiment, recommendation engine 130 converts prioritized recommendations into structured feedback instructions optimized for delivery modalities. For example, a recommendation to correct wrist alignment during a shooting event may be converted into: audio feedback: “adjust your wrist inward by 5 degrees for better shot accuracy;” visual feedback: a highlighted trajectory arc overlaying the optimal shooting path in a VR environment, with wrist joint positions marked for correction; haptic feedback: a gentle vibration on the wrist-worn wearable device signaling an incorrect hand position. In certain embodiments, feedback generation can incorporate user preferences and contextual factors retrieved from user profile database 238 and event data repository 232. For example, if a user prefers audio instructions and is engaged in a high-intensity endurance drill, the system may prioritize concise audio feedback, such as “Take a recovery break for two minutes,” over detailed visual overlays to minimize cognitive load. Feedback generation can also address multiple performance insights within a single event. For instance, during a dribbling session, the system may combine feedback on hand-to-ball timing and torso posture into a structured instruction: “Reduce ball contact delay by 0.1 seconds and keep your torso upright to improve dribbling control.” This ensures that feedback remains actionable while addressing multiple deficiencies. In an embodiment, confidence scores and event-specific metadata may influence the formatting of the generated feedback. For example, if a recommendation has a high confidence score (e.g., 95%) and involves critical biomechanical corrections, the system may emphasize the instruction with additional auditory or visual prompts. Conversely, lower-confidence recommendations may be presented as secondary suggestions. The generated feedback includes contextual metadata to support downstream delivery at step 516. For example, a generated feedback package may include: feedback type: audio, visual, or haptic; instruction: “adjust wrist inward by 5 degrees;” confidence score: 95%; event context: shooting event, free-throw line; delivery timestamp: 15:24:10. The generated feedback can be passed to Model-based feedback generation system 140 at step 516 for delivery to the user in the preferred format. By generating structured, actionable, and prioritized feedback, step 514 ensures that the system provides meaningful guidance aligned with the user's training goals and performance needs.

At step 516, the system provides the generated feedback to the user through Model-based feedback generation system 140. More specifically, Model-based feedback generation system 140 delivers the structured feedback produced at step 514 in the user's preferred modality, such as audio instructions, visual overlays, or haptic signals, enabling the user to take immediate corrective actions during training sessions or review insights post-session. In an embodiment, audio feedback can be delivered through connected user devices, such as smartphones, tablets, or VR headsets. For example, during a shooting drill, Model-based feedback generation system 140 may output: “Adjust your wrist angle inward by 5 degrees for improved shot accuracy.” Audio feedback is dynamically synchronized with the training session to ensure timely delivery of actionable instructions. In certain embodiments, visual feedback can be provided in real-time or post-session using graphical overlays. For instance, during a shooting session in a VR training environment, Model-based feedback generation system 140 may display: s trajectory arc overlay showing the optimal ball path; graphical markers highlighting incorrect wrist and elbow positions; annotations specifying joint-angle deviations (e.g., “Wrist misaligned by 8° inward”). In an embodiment, haptic feedback can be delivered through wearable devices, such as wristbands or ankle monitors, to provide tactile guidance. For example, during a dribbling drill, Model-based feedback generation system 140 may trigger a vibration on the wrist to indicate delayed ball contact timing, prompting the user to adjust their hand motion for improved control. Similarly, during defensive movement drills, subtle vibrations can signal improper positioning or alignment. Feedback delivery may be adjusted dynamically based on user preferences and training conditions retrieved from user profile database 238. For example, during a high-intensity training session, Model-based feedback generation system 140 may prioritize concise audio cues over detailed visual overlays to reduce cognitive load. Conversely, during post-session reviews, detailed visual feedback and analysis may be presented for comprehensive performance evaluation. In accordance with various embodiments, the system can support multi-modal feedback delivery, combining auditory, visual, and haptic instructions for reinforcement. For instance, during a shooting session: audio: “adjust your wrist by 5 degrees;” visual: highlighted trajectory arc and wrist-angle markers in VR; haptic: wrist vibration reinforcing the correction. The provided feedback can include contextual metadata, such as event type, performance metrics, and timestamps, to enhance understanding. For example, Model-based feedback generation system 140 may display: “Shooting event at 15:22:08—Wrist misalignment corrected from 10° to 2°, shot release speed improved to 0.3 seconds.”

At step 518, the system updates the user profile or stores the generated feedback, performance metrics, and contextual metadata for further processing. More specifically, the outputs provided by Model-based feedback generation system 140 and recommendation engine 130 are logged into relevant data stores, such as user profile database 238, recommendation history 236, and event data repository 232, enabling longitudinal performance tracking, personalized training adjustments, and future analysis. In an embodiment, user profile database 238 can be updated with user-specific performance metrics, training history, and feedback responses. For example, after a shooting drill, the system may log: performance metrics: shot release speed reduced to 0.3 seconds, wrist angle deviation corrected to 2°; feedback provided: “adjust wrist angle inward by 5°;” training outcomes: shot accuracy improved by 8% during the session. In an embodiment, this data can be appended to the user's training profile to enable personalized adjustments in future sessions. In certain embodiments, recommendation history 236 stores historical records of recommendations and user responses. For instance, the system may log that the user corrected wrist alignment based on prior feedback but continued to exhibit slow shot release timing. Storing this information allows recommendation engine 130 and prioritization module 240 to avoid redundant feedback and focus on addressing persistent issues during subsequent sessions. Event data repository 232 can store session-specific insights and validated event classifications for further analysis or model refinement. For example, biomechanical outputs, such as joint angles and movement velocities, are stored alongside session metadata, including timestamps, sensor identifiers, and spatial coordinates. These records can later be retrieved for post-session reviews or for refining machine learning models within training system 150. In an embodiment, step 518 supports bidirectional workflows where stored data informs future training recommendations, feedback prioritization, and model updates. For example: user profile database 238 may provide historical performance trends to prioritize future training goals; recommendation history 236 may inform prioritization module 240 to emphasize new feedback over previously addressed corrections; event data repository 232 may provide session data to training system 150 to retrain analytical models and improve event detection accuracy. In certain embodiments, the system can apply secure storage protocols, such as AES encryption, to ensure the integrity and confidentiality of stored data. Access to user-specific data, such as training outcomes and biometric insights, may be restricted to authorized system components to safeguard sensitive information.

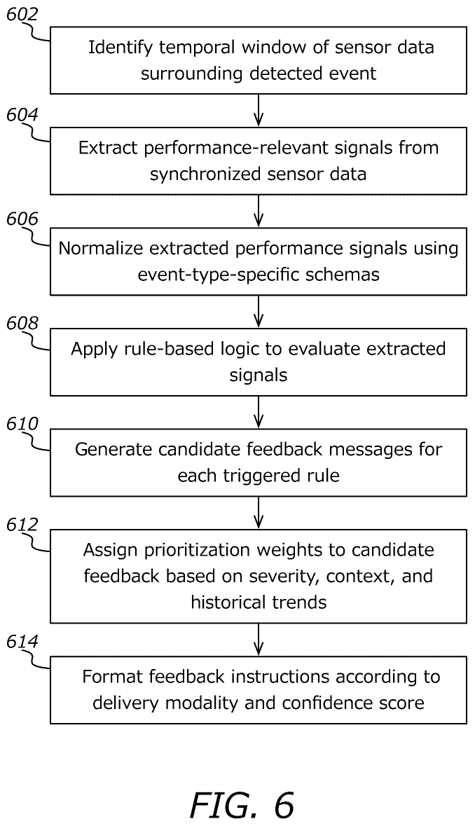

FIG. 6 illustrates an exemplary process for extracting localized performance signals from sensor data, evaluating the signals using rule-based logic, and generating prioritized feedback instructions in accordance with various embodiments. The process begins after an event has been detected and classified (e.g., via event type detector 222), and focuses on the subsequent technical operations that analyze synchronized multi-modal data and generate actionable, modality-specific recommendations. Each step is performed by one or more components within recommendation engine 130 and Model-based feedback generation system 140, including but not limited to: performance signal extractor 308, rule-based evaluation engine 310, feedback prioritization module 312, and message formatting module 314. Although the process is shown in linear form, steps 608-612 are implemented using a dynamic rule activation and prioritization graph, as described in more detail below.

At step 602, a bounded temporal window of sensor data is identified surrounding the detected event. The temporal window defines the scope of subsequent analysis by isolating the relevant frame range across synchronized sensor modalities, such as motion signals, pose sequences, biometric indicators, and contextual metadata. For example, a window may span a fixed duration (e.g., two seconds before and after the event timestamp) or be dynamically adjusted based on the detected event type. In certain embodiments, performance signal extractor 308 is operable to perform the window extraction by locating the event timestamp and retrieving the corresponding interval across all relevant sensor streams. For instance, if a jump event is detected at t=18.25 s, a window from t=16.25 s to t=20.25 s may be extracted from synchronized IMU, video, and heart rate data for targeted signal processing.

At step 604, performance-relevant signals are extracted from the windowed multi-modal sensor data. This includes isolating features that are semantically or biomechanically meaningful for the type of detected event. For example, for a jump shot event, relevant signals may include vertical acceleration, hip displacement, and wrist angle at release. The extraction may operate over synchronized data sources, such as pose-derived joint coordinates from video, inertial data from IMUs, and biometric signals like heart rate or galvanic skin response. In certain embodiments, performance signal extractor 308 is operable to apply signal parsing techniques, including velocity and angular rate computation, low-pass filtering, and landmark trajectory segmentation, to derive these event-specific signals from the bounded windowed region.

At step 606, the extracted performance signals are normalized and mapped to event-type-specific schemas. Normalization may include rescaling numerical values (e.g., min-max or z-score), converting units (e.g., from pixels to meters), and aligning coordinate systems (e.g., body-centric vs. global). Each schema provides a structured representation tailored to the detected event type—such as a jump, pass, or pivot—defining which features are required and how they are formatted. For example, a jump schema may require hip angle trajectory, vertical force vector, and flight time, each expressed in consistent units and frame-aligned structure. In certain embodiments, performance signal extractor 308 is operable to apply schema-aligned transformations to the raw signals, resolving inconsistencies in sampling rates, spatial references, and formatting conventions to yield a fully structured signal set for evaluation.

At step 608, rule-based logic is applied to the schema-normalized performance signals to evaluate user performance against predefined criteria. This logic operates on a condition-action model, where each rule defines a set of structured preconditions and an associated feedback response. Rather than executing sequentially, the system traverses a condition graph to identify only those rules whose conditions are satisfied by the current signal set. For example, a rule may specify that wrist_angle_deviation must exceed 5 degrees and vertical_force must fall below a defined threshold. If both conditions are met within the schema-mapped signal set, the rule is activated and flagged for downstream feedback generation. In certain embodiments, rule-based evaluation engine 310 is operable to evaluate multiple rule branches in parallel by traversing a rule activation graph. Each node in the graph represents a condition, and each edge denotes an activation path toward a feedback-generating rule. This structure allows the system to dynamically activate only relevant rules based on user-specific signal context and suppress inapplicable branches, thereby improving computational efficiency and personalizing the feedback trajectory. Rules may also encode condition weights or thresholds adapted to event type, session conditions, or athlete profile metadata received from athlete profile datastore 330.

At step 610, the system generates candidate feedback messages for each activated rule. Each rule includes a predefined feedback template that is instantiated with values from the schema-normalized signal set. For example, a rule evaluating joint angle deviation may generate a message such as “Reduce wrist extension by 7° during follow-through,” where the numerical value and anatomical term are dynamically populated. This message generation process operates at the machine level—matching data-bound variables to template slots and tagging each message with relevant metadata, including event type, session identifier, rule ID, and signal confidence indicators. In certain embodiments, candidate feedback messages are structured using a standardized message format, enabling downstream components (e.g., feedback prioritization module 312 or message formatting module 314) to consume and route messages efficiently. Each message may include: (i) a content field comprising the synthesized recommendation; (ii) a rule reference ID for traceability; (iii) signal references that triggered the message; and (iv) a modality compatibility profile to assist later formatting stages. These structured outputs ensure technical interoperability across components and facilitate auditability in performance review workflows.

At step 612, the system assigns prioritization weights to each candidate feedback message based on contextual metadata, severity of deviation, and user-specific performance trends. Each message is scored according to a weighted framework that evaluates factors such as: (i) the magnitude of deviation from the expected signal value; (ii) relevance to current session objectives (e.g., fatigue management vs. accuracy focus); and (iii) historical persistence of the identified issue in the user's profile. This step enables the system to determine which feedback messages are most impactful and timely for delivery. In certain embodiments, the prioritization weights are computed using a scoring engine configured to apply rule-specific severity coefficients, user-specific performance decay models, or fatigue-aware modifiers. For example, a message concerning a recurring shot release delay may receive a higher weight if the user has exhibited declining performance in high-exertion sessions. The output of this step is a ranked list of candidate messages, each annotated with a prioritization score and contextual metadata to guide subsequent formatting and delivery.

At step 614, the system formats the prioritized feedback messages into delivery-ready instructions that are tailored to the intended output modality and associated confidence score. This formatting includes selecting the appropriate presentation mode (e.g., audio, visual overlay, haptic), structuring the message content based on user preferences, and incorporating confidence-adjusted emphasis cues (e.g., signal strength, repetition, or clarity level). Formatting is guided by delivery context parameters such as the user's device capabilities, current activity state, and attention load. For example, a feedback message with high confidence may be formatted as a visual overlay showing an ideal limb trajectory superimposed on the user's pose in a VR headset, while lower-confidence messages may be delivered via subtler audio prompts or logged for post-session review. In certain embodiments, the formatting logic references metadata from the user profile database to apply preferred phrasing styles, select units of measurement (e.g., metric vs. imperial), or determine pacing for sequential feedback delivery. The formatted instruction set is then passed to Model-based feedback generation system 140 for execution in the delivery workflow.

Although the process from step 608 through step 612 is illustrated linearly in FIG. 6, the underlying system executes a conditionally triggered evaluation across a graph of structured rules. Each rule in the evaluation graph is associated with a schema-aligned condition set—e.g., wrist_angle_deviation>5° AND heart_rate<130 bpm—and is mapped to a corresponding feedback message template. Upon receiving the normalized performance signals from step 606, the system traverses this graph to evaluate only those rules whose conditions are satisfied by the current input vector. For example, during a shooting event, if the normalized schema indicates excessive wrist deviation but stable cardiovascular output, only the wrist-alignment-related rules are activated and passed forward. The prioritization logic in step 612 then evaluates these active rules based on multiple metadata dimensions, such as severity of deviation, user-specific trends, and contextual session factors. For instance, if the user historically undercorrects wrist posture despite repeated feedback, the system may elevate the urgency score of this rule to influence downstream formatting and delivery. This graph-based activation framework supports modular, scalable rule definition while ensuring that only relevant feedback is prioritized. It enables technically distinct, non-linear execution of rule logic that aligns with schema-aware signal modeling—reinforcing the architecture's machine-executed transformation and decision-making workflow.

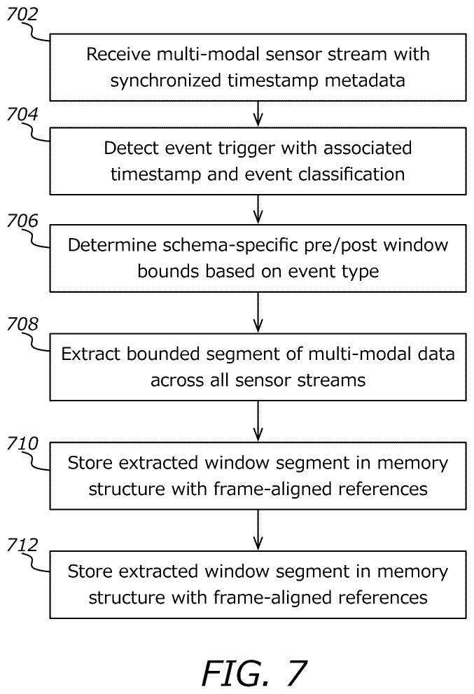

FIG. 7 illustrates an exemplary process for extracting a temporal window of multi-modal sensor data surrounding a detected event in accordance with various embodiments. The process shown in FIG. 7 provides additional detail for step 602 of FIG. 6 and emphasizes schema-specific windowing logic performed on aligned, multi-sensor data streams. The steps may be performed by components of the event detection system 120 and related subsystems, including performance signal extractor 308.

At step 702, the system receives a stream of multi-modal sensor data, each sample including synchronized timestamp metadata. The input stream may include video frames, inertial measurement unit (IMU) samples, biometric readings, positional data, and contextual signals such as environmental lighting or surface conditions. Each signal type is associated with a distinct sampling rate and may originate from a different hardware source. The incoming data is pre-aligned using the temporal alignment techniques described in step 504 of FIG. 5, including timestamp reconciliation and optional use of Kalman filters or pose-anchored re-alignment.

At step 704, the system detects an event trigger, comprising both a classification label and an associated timestamp. This trigger may be generated by event type detector 222, based on schema-aligned features from prior steps. For example, a shooting motion may be detected at time T=65.2 seconds. The classification label (e.g., “shooting”) and the trigger timestamp are propagated forward to guide window extraction.

At step 706, the system determines schema-specific pre/post bounds for the extraction window based on the detected event type. For example, if the event type is a “jump shot,” the schema may specify that two seconds prior and one second after the event timestamp be included in the extraction window. These bounds are defined per event class to capture relevant biomechanical and contextual signals. The bounds are computed relative to the synchronized timestamps, and may vary for different modalities (e.g., a shorter lead-in period for IMU signals versus video frames).

At step 708, the system extracts the bounded segment of multi-modal data based on the previously determined schema bounds. The segment includes temporally aligned data from each sensor type, clipped to the window range. For instance, a pose stream may contribute 180 frames at 60 fps, while a heart rate stream may yield three interpolated samples from a 1 Hz sampling rate. Missing data in a given stream may be handled through interpolation or exclusion, depending on confidence thresholds or system rules.

At step 710, the extracted data segment is stored in a memory structure that maintains frame-aligned references. The memory structure may use a sliding buffer or indexed record format, where each sample is associated with a unified timestamp domain. This enables downstream modules to access synchronized data slices across all sensor types.

At step 712, the memory structure may optionally support metadata tagging to mark source modality, signal confidence, or rule-triggered annotations. These tags assist later stages, such as rule-based evaluation (step 608) and prioritization (step 612) by providing context-aware access to the extracted window. In an embodiment, the structure allows efficient retrieval of the extracted window as an atomic unit for further processing by rule-based or machine learning evaluation engines.

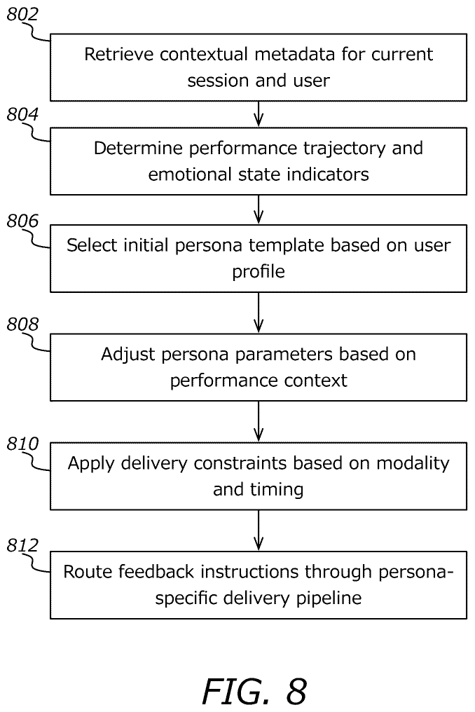

FIG. 8 illustrates an exemplary process for dynamically configuring an AI coach persona in accordance with user-specific context and performance trajectory. This process is performed by components within model-based feedback generation system 140, including persona response engine 404, recommendation delivery controller 402, and user engagement logger 416. Each step represents a machine-executed transformation that adapts delivery tone, timing, and modality based on contextual metadata and sensor-derived indicators.

At step 802, the system retrieves contextual metadata associated with the current user and session. This metadata may include user identifiers, engagement history, recent performance trends, session-specific goals, and real-time sensor-derived indicators (e.g., elevated heart rate, missed cues, posture slouch). Metadata can be retrieved from athlete profile datastore 330 and performance metric log 332.

At step 804, the system determines the user's performance trajectory and infers emotional state indicators. Performance trajectory may be calculated as a rolling average of signal-based metrics (e.g., movement smoothness, shot accuracy, reaction time) and interpreted using time-series models or heuristic rules. Emotional state indicators can be inferred from biometric patterns (e.g., HRV suppression), behavioral trends (e.g., repeated hesitation), or engagement metrics (e.g., reduced response latency).

At step 806, the system selects an initial persona template from a predefined set of response archetypes, such as “encouraging mentor,” “competitive coach,” or “calm instructor.” This selection is based on static attributes in the user's profile (e.g., preferred tone, coaching style) and dynamic context derived from the prior steps. Persona templates include delivery parameters such as vocal tone, cadence, word choice, and response escalation rules.

At step 808, the system adjusts one or more parameters of the selected persona template based on real-time performance context. For example, if the user exhibits signs of frustration (e.g., short bursts of aggressive motion, rising heart rate), the tone may be softened or the instructional density reduced. If performance is trending positively, the system may increase directive complexity or introduce challenge-based prompts. These adjustments are applied by persona response engine 404 using rule sets or reinforcement-trained models.

At step 810, the system applies delivery constraints based on current modality and timing windows. Modality-specific constraints include the availability of audio, visual, or haptic channels (e.g., speaker disconnected, AR headset inactive). Timing constraints may involve suppression windows to avoid cognitive overload (e.g., spacing feedback 5 seconds apart) or synchronization with natural breaks in user activity (e.g., end of repetition or play segment).

At step 812, the system routes the finalized feedback instruction set through a persona-specific delivery pipeline managed by recommendation delivery controller 402. This includes passing modality-formatted outputs to downstream modules, such as speech synthesis module 406, visual overlay generator 410, spatial audio renderer 408, and haptic feedback controller 412. Routing decisions are logged for replayability, auditability, and personalization tuning in future sessions.

In various embodiments, fallback personas may be cached locally on user devices to ensure continuity in the absence of real-time context inference. Additionally, overrides may be applied by system administrators or training staff to enforce fixed delivery styles for specialized sessions (e.g., recovery mode, test environment).

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Any of the above-mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above-mentioned systems, units, modules, engines, controllers, components, interfaces or the like may use and/or comprise an application programming interface (API) for communicating with other systems units, modules, engines, controllers, components, interfaces or the like for obtaining and/or providing data or information.

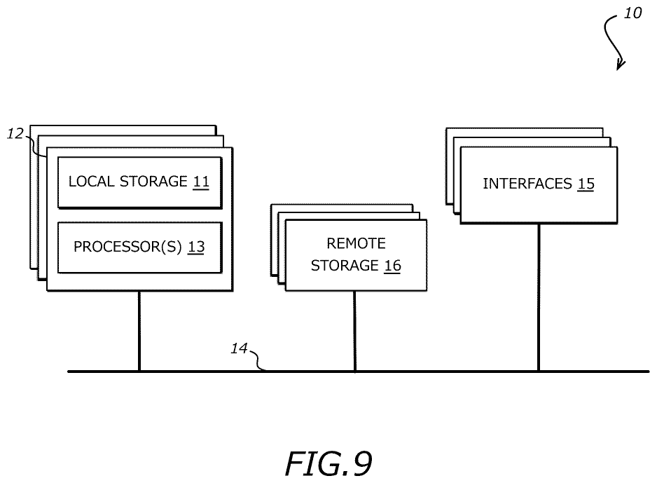

Referring now to FIG. 9, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 9 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

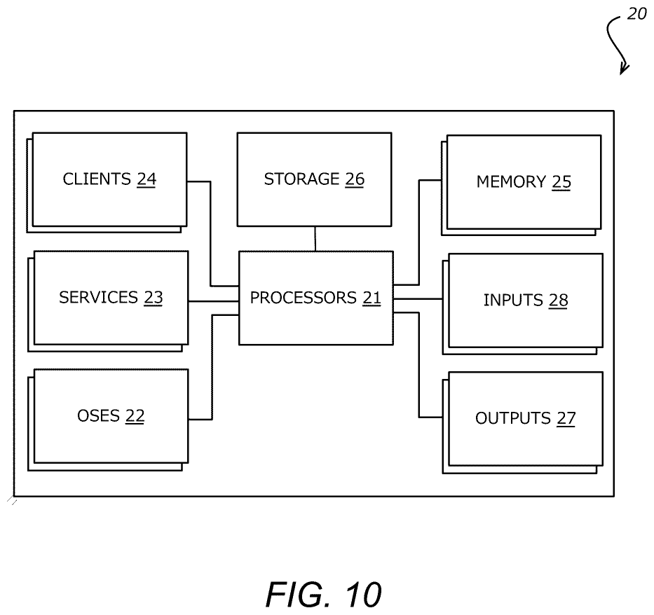

In some embodiments, systems may be implemented on a standalone computing system. Referring now to FIG. 10, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 9). Examples of storage devices 26 include flash memory, magnetic hard drive, CD-ROM, and/or the like.

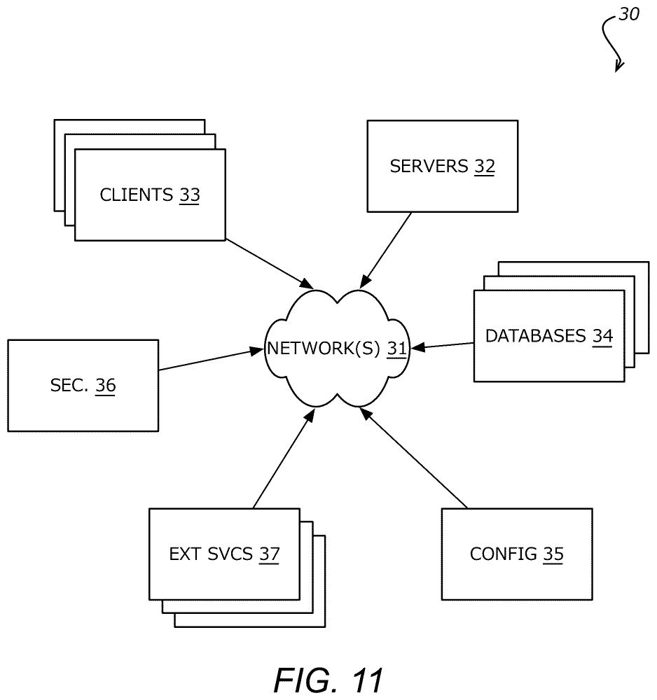

In some embodiments, systems may be implemented on a distributed computing network, such as one having any number of clients and/or servers. Referring now to FIG. 11, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

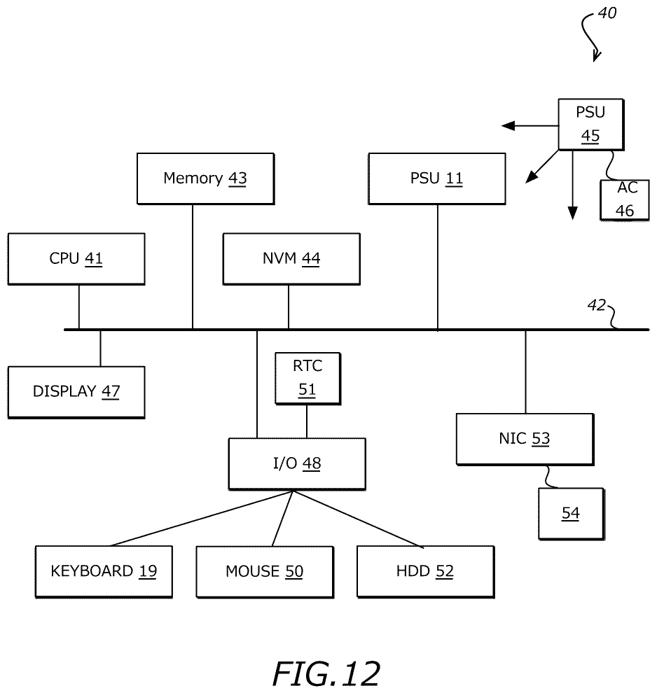

FIG. 12 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present) , and both A and B are true (or present) .

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system for multi-modal event detection, performance evaluation, and adaptive feedback delivery in a sports training environment, the computing system comprising:
a processor; and
a memory storing instructions that, when executed by the processor, cause the computing system to:
receive multi-modal input data from a plurality of sensors associated with a user, the multi-modal input data comprising at least one of motion data, video data, biometric signals, and environmental data;
process the multi-modal input data using synchronization logic to generate a unified dataset aligned across sensor types and temporal dimensions;
apply an event detection model to the unified dataset to identify a candidate performance event associated with the user, the event detection model trained to classify a plurality of predefined event types based on motion and video patterns;
segment a temporal portion of the unified dataset corresponding to the candidate performance event;
extract pose data from the temporal portion;
evaluate the pose data using an event-specific analysis model to compute at least one performance metric corresponding to the candidate performance event;
retrieve a user profile record from a user datastore, the user profile record comprising prior performance metrics, training context data, and coaching configuration parameters associated with the user;
generate at least one recommendation based on the at least one performance metric and the user profile record, the at least one recommendation comprising a feedback instruction linked to the candidate performance event;
assign a priority value to the at least one recommendation using a scoring engine operable to apply rule-based logic and user-specific weighting parameters;
select a feedback modality based on the priority value and the coaching configuration parameters, the feedback modality comprising at least one of audio output, visual output, or haptic output; and
provide a feedback signal to a user device interface associated with the user, the feedback signal configured to initiate delivery of the feedback instruction using the feedback modality.

2. The computing system of claim 1, wherein the event detection model is trained to detect a plurality of event types includes at least one of a movement initiation event, a posture transition event, a repetition failure event, a target acquisition event, or a user-defined custom event.

3. The computing system of claim 1, wherein applying the event-specific analysis model comprises:
selecting the event-specific analysis model from a plurality of models including at least one of a biomechanical model, a kinematic model, or a decision analysis model.

4. The computing system of claim 3, wherein applying the event-specific analysis model further comprises:
computing the at least one performance metric using the unified dataset;
extracting at least one of joint position data, joint angle data, temporal motion sequences, or force approximation values from the unified dataset to generate extracted data; and
evaluating the extracted data using the event-specific analysis model to produce the at least one performance metric.

5. The computing system of claim 4, wherein the event-specific analysis model comprises a kinematic model configured to evaluate angular velocity, linear acceleration, or segment trajectories associated with user movement.

6. The computing system of claim 1, wherein the scoring engine is operable to compute the priority value by applying at least one rule-based scoring heuristic in view of the coaching configuration parameters and at least one prior performance metric from the user profile record.

7. The computing system of claim 6, wherein the scoring engine is further operable to apply a tie-breaking rule to assign the priority value when two or more recommendations satisfy a scoring heuristic within a predefined margin.

8. The computing system of claim 1, wherein selecting the feedback modality comprises identifying a delivery channel associated with the user device interface and mapping the feedback instruction to a format compatible with the delivery channel.

9. The computing system of claim 1, further configured to:
in response to receiving a replay request associated with the candidate performance event, generate a replay context record comprising a unified dataset segment, the at least one performance metric, and the feedback instruction; and
associate the replay context record with a session identifier for subsequent retrieval and review.

10. The computing system of claim 9, wherein the replay context record is linked to the candidate performance event and is configured to initiate replay of the temporal portion, and wherein the feedback instruction is delivered using the feedback modality during the replay.

11. A computer-implemented method for multi-modal event detection, performance evaluation, and adaptive feedback delivery in a sports training environment, comprising:
receiving multi-modal input data from a plurality of sensors associated with a user, the multi-modal input data comprising at least one of motion data, video data, biometric signals, and environmental data;
processing the multi-modal input data using synchronization logic to generate a unified dataset aligned across sensor types and temporal dimensions;
applying an event detection model to the unified dataset to identify a candidate performance event associated with the user, the event detection model trained to classify a plurality of predefined event types based on motion and video patterns;
segmenting a temporal portion of the unified dataset corresponding to the candidate performance event;
extracting pose data from the temporal portion;
evaluating the pose data using an event-specific analysis model to compute at least one performance metric corresponding to the candidate performance event;
retrieving a user profile record from a user datastore, the user profile record comprising prior performance metrics, training context data, and coaching configuration parameters associated with the user;
generating at least one recommendation based on the at least one performance metric and the user profile record, the at least one recommendation comprising a feedback instruction linked to the candidate performance event;
assigning a priority value to the at least one recommendation using a scoring engine operable to apply rule-based logic and user-specific weighting parameters;
selecting a feedback modality based on the priority value and the coaching configuration parameters, the feedback modality comprising at least one of audio output, visual output, or haptic output; and
providing a feedback signal to a user device interface associated with the user, the feedback signal configured to initiate delivery of the feedback instruction using the feedback modality.

12. The computer-implemented method of claim 11, wherein processing the multi-modal input data comprises:
performing temporal alignment using timestamp normalization and sensor drift correction to produce the unified dataset.

13. The computer-implemented method of claim 11, wherein receiving the multi-modal input data comprises:
receiving a video stream and one or more biometric signals from a wearable sensor system, the wearable sensor system comprising at least one of an inertial measurement unit, a heart rate monitor, or a muscle activation sensor.

14. The computer-implemented method of claim 11, further comprising extracting temporal motion features from the unified dataset, the temporal motion features comprising at least one of movement velocity, movement acceleration, or inter-frame pose variation.

15. The computer-implemented method of claim 11, further comprising:
adjusting the at least one recommendation based on environmental data associated with the candidate performance event, the environmental data comprising at least one of location context, weather conditions, or ambient noise levels.

16. The computer-implemented method of claim 11, further comprising updating the user profile record to include the at least one performance metric, the assigned priority value, and feedback delivery metadata associated with the candidate performance event.

17. A non-transitory computer-readable medium storing instructions that, when executed by one or more processors, cause a computing system to:
receive multi-modal input data from a plurality of sensors associated with a user, the multi-modal input data comprising at least one of motion data, video data, biometric signals, and environmental data;
process the multi-modal input data using synchronization logic to generate a unified dataset aligned across sensor types and temporal dimensions;
apply an event detection model to the unified dataset to identify a candidate performance event associated with the user, the event detection model trained to classify a plurality of predefined event types based on motion and video patterns;
segment a temporal portion of the unified dataset corresponding to the candidate performance event;
extract pose data from the temporal portion;
evaluate the pose data using an event-specific analysis model to compute at least one performance metric corresponding to the candidate performance event;
retrieve a user profile record from a user datastore, the user profile record comprising prior performance metrics, training context data, and coaching configuration parameters associated with the user;
generate at least one recommendation based on the at least one performance metric and the user profile record, the at least one recommendation comprising a feedback instruction linked to the candidate performance event;
assign a priority value to the at least one recommendation using a scoring engine operable to apply rule-based logic and user-specific weighting parameters;
select a feedback modality based on the priority value and the coaching configuration parameters, the feedback modality comprising at least one of audio output, visual output, or haptic output; and
provide a feedback signal to a user device interface associated with the user, the feedback signal configured to initiate delivery of the feedback instruction using the feedback modality.

18. The non-transitory computer-readable medium of claim 17, wherein evaluating the pose data using the event-specific analysis model comprises:
computing the at least one performance metric using the unified dataset;
extracting at least one of joint position data, joint angle data, temporal motion sequences, or force approximation values from the unified dataset to generate extracted data; and
evaluating the extracted data using the event-specific analysis model to produce the at least one performance metric.

19. The non-transitory computer-readable medium of claim 17, further comprising instructions that, when executed, cause the computing system to:
generate a replay context record associated with the candidate performance event, the replay context record comprising the unified dataset, the at least one performance metric, and the feedback instruction; and
associate the replay context record with a session identifier for subsequent retrieval and review.

20. The non-transitory computer-readable medium of claim 19, wherein the replay context record is configured to initiate replay of the temporal portion, and wherein the feedback instruction is delivered using the feedback modality during the replay.
